(19) United States
(12) Patent Application Publication
(10) Pub. No.: US 2003/0201232 A1
(43) Pub. Date: Oct. 30, 2003

(54) Flotation/fractionation systems for treating liquids and in separation of liquids to be treated thereby

(76) Inventor: Matthew Cheyne, Western Australia (AU)

Correspondence Address: John C. Kerins, MILES & STOCKBRIDGE P.C., Suite 500, 1751 Pinnacle Drive, McLean, VA, 22102, US

(21) Appl. No.: 10/125,832

(22) Filed: Apr. 29, 2002

(51) Int. Cl. C02F 1/24

(52) U.S. Cl. 210/703; 210/221.2

(57) ABSTRACT

An improvement in a fractionation/flotation system for removing waste such as biosolids, nitrates or nitrites from a liquid containing same and an apparatus for separating liquid containing particles of varying mass or specific gravity. A reactor vessel 153 comprises a fractionation column 153a and a foam aggregation chamber 153b surmounting the column. Liquid containing the waste is pumped into the fractionation column 153a via a pump 105 and an outlet 159 that branches into a first inlet 163 and a second inlet 165. These inlets inject liquid into the fractionation chamber 153a at intermediate locations that are axially spaced apart, where the first inlet entry 163a is higher than the second inlet entry 165a. A waste reducing gas such as air, oxygen or ozone is injected into the second inlet immediately prior to insetting the liquid into the fractionation column 153a. Foam generated from the inlet liquid has biosolids adsorbed thereto and is collected within the aggregation chamber 153b for extraction. An outlet 173 for treated liquid is provided at the base of the fractionation column 153a. The separating apparatus 127 comprises an elongated passageway 133 having a primary lip 129a for liquid containing particles to flow over into the passageway. A secondary lip 129b is disposed lower than the primary lip 129a for liquid to flow over and out of the passageway 133 after being diverted. Flow is diverted within the passageway 133 by a circular suction pipe 141 into either a convolving recirculating portion 145 and a discharging portion 147. Liquid in the recirculating portion 145 contains particles of relatively lower mass or specific gravity as is extracted from the passageway via holes 143 and the pump 105 providing suction thereto. This liquid is inlet to the protein skimmer 125 comprising the flotation/fractionation system. Liquid in the discharging portion 147 contains particles of higher mass or specific gravity which flows out of the passageway 133 and over the secondary lip 129b to a biofilter 131.

### FIELD OF THE INVENTION

This invention relates to an improved control arrangement for flotation/fractionation systems incorporating a reactor vessel and a particle separator therefore. The invention has particular, but not exclusive, utility as a protein skimmer to supplement the treatment of liquid containing biomass and waste from aquatic species within a holding tank.

The invention also relates to a tank system for accommodating aquatic life and a method therefore. The invention has particular, although not exclusive, utility in accommodating live fish including shellfish, and especially rock lobster and abalone for holding and display purposes.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The use of flotation/fractionation systems incorporating a reactor vessel to function as what is commonly termed “a protein skimmer” is known in the art of treating water for sustaining aquatic species in holding tanks. An example of one form of protein skimmer used in the art is described in U.S. Pat. No. 4,834,872. This type of protein skimmer provides for the aftertreatment of liquid circulated therethrough by charging it with oxygen and removing residual biomass and nitrite to the extent that it can be fed back into an aquarium or the like from which the liquid was taken for treatment. Whilst this form of protein skimmer is effective for use with smaller types of aquaria, due to the complexity of its design, it is not suitable for treating comparatively large volumes of liquid, such as are involved with the operating of large holding tanks for aquatic species.

In larger tank systems, a simpler form of protein skimmer design is utilized for cost effectiveness. Two examples of prior art systems used in larger tank systems are schematically shown in FIGS. 1A and 1B of the drawings.

FIG. 1A shows a protein skimmer design involving the use of a single pump 11′, which pumps liquid via an inlet 13′ from a holding tank 15′. The outlet 17′ of the pump 11′ directs liquid via a convolved pipe arrangement 19′ into a main fractionation column 21′ of a reactor vessel 23′, at an intermediate position therealong. The pipe arrangement 19 incorporates a venturi 25′ in series therewith for injecting an ozone/oxygen mix via an inlet line 27′ from a concentrated source (not shown) into the pipe arrangement and consequently into the fractionation column 21′. The reactor vessel 23′ includes an aggregation chamber 29′ surmounting the fractionation column 21′ for collecting foam generated by the injection of the liquid entrained with the ozone/oxygen gas mix into the fractionation column 21′ and the permeation of liquid within the column with rising bubbles of this gaseous mixture. An outlet pipe 31′ is connected to the base of the fractionation column 21′ to remove the lower treated fraction of liquid from the reactor vessel 23′ and return it to the holding tank 15′.

As described in U.S. Pat. No. 4,834,872, nitrites are reduced and nitrates neutralized by the oxidizing effect of the ozone/oxygen gas mix bubbling through the fractionation column 21′ and any residual biomass is adsorbed to the resultant foam floated and ultimately collected within the aggregation chamber 29′.

The throughput of liquid through the reactor vessel 23′ is determined by the control of the pump 11′. The throughput effects the residency time level of liquid within the reactor vessel and is important to control to ensure that sufficient time is allowed for liquid to be eradicated of nitrites, nitrates and biomass whilst it is resident within the reactor vessel. The pump 11′ also affects the flow rate of liquid through the venturi 25′ and hence the amount of ozone and oxygen gas drawn into the liquid flow. Essentially, the faster the flow through the venturi, the greater is the volume of ozone and oxygen gas that is drawn into the flow. Furthermore, the faster the resultant fluid flow into the fractionation column 21′ is, the greater is the turbidity caused within the fractionation column. The amount of gas within the reactor vessel 23′ determines the head pressure of the column and hence the resultant level of liquid within the fractionation column 21′. Accordingly, it is desirable to maximize the flow rate of liquid through the venturi 25′ as the venturi intrinsically restricts flow in any event. It is also desirable to fix the level of liquid within the reactor vessel 23′ so that its surface is just below the junction between the fractionation column 21′ and the aggregation chamber 29′. This facilitates the aggregation of foam within the aggregation chamber 29′ and keeps it dry so as not to lose liquid unnecessarily during the treatment fractionation/floatation process.

A problem that arises with this system is that it is not possible to control the operation of the pump 11′ in a manner so that all of the parameters influenced by it are optimally set, especially when it is necessary to adjust one parameter and not another in order to achieve optimum operating efficiency of the system.

For example, when it is desirable to maximize the flow rate of the liquid through the venturi 25′ to maximize the volume of gas being introduced into the fractionation column 21′ for aeration and flotation purposes, this may result in throughput being too fast and the level of liquid within the fractionation column reducing. This is due to an increase in the head pressure of the reactor vessel provided by a direct increase in the ratio of gas to liquid within the vessel. This reduction in liquid level will cause the surface of the liquid to fall well below the junction between the fractionation column 21′ and the aggregation chamber 29′, resulting in a reduced volume of liquid being treated by the gas mix and not all of the foam being able to be collected in the aggregation chamber. To optimally treat the liquid, the height of liquid in the reactor vessel needs to be at a maximum.

Conversely, maximising the level of liquid within the reactor vessel 23′ requires the flow rate of liquid entering the fractionation column 21′ to be reduced to an extent that the ratio of gas to liquid in the column reduces the head pressure of liquid therein and allows the level to rise. This, however, results in reduced turbidity and aeration of the liquid with ozone and oxygen gas to properly treat the liquid therein, although residency time increases, due to the resultant decrease in throughput.

Although a reasonable compromise may be able to be achieved, the problem is exacerbated further by the fact that the degree of foaming that occurs to allow adsorption of biomass to foam and thus lifting of the same out from solution, is dependent upon the amount of protein containing the nitrites and nitrates in the liquid. The more protein there is in the incoming liquid from the tank that needs to be fractioned and floated out of the liquid, the more foam there is generated. As the amount of protein in the liquid is dependent on the aquatic species residing in the holding tank 15′, and totally independent of the operation of the pump 11′, there is a need to dissociate the control of the pump effecting throughput and hence residency time of liquid within the reactor vessel 23′, from control of the flow rate of liquid through the venturi 25′, which effects turbidity and the level of liquid within the column.

This problem is addressed in the protein skimmer design shown in FIG. 1B by taking the convolved pipe arrangement 19′, including the venturi 25′, out of the inlet side of the pipe circuit and creating a discrete recirculation pipe circuit 33′ incorporating the same, which has its own pump 35′. This second pump 35′ operates quite independently of the main inlet pump 11′ that controls throughput, so that control of the second pump determines the flow rate of liquid through the venturi 25′ and hence the level of liquid within the reactor vessel 23′, quite independently of the throughput.

As shown in the drawing, the outlet 17′ of the first pump 11′ is connected to the fractionation column 21′ at an intermediate location 36′ along the column to directly inject liquid to be treated therein. Thus the rate of flow of this pump 11′ determines the throughput and hence residency time of liquid within the reactor vessel 23′. The recirculation pipe circuit 33′ has an inlet 37′ connected proximate to the base of the fractionation column 21′ to extract liquid therefrom and supply the second pump 35′. The outlet 39′ of the second pump 35′ is connected to the convolved pipe arrangement 19′ incorporating the venturi 25′. The outlet of the venturi 25′ injects liquid into the fractionation column 21′ at an intermediate, albeit lower, location 41′ than location 36′, where the outlet 17′ from the first pump 11′ injects liquid into the column. This allows the untreated liquid delivered via the first pump 11′ to be permeated by the rising gas mix injected from the outlet of the venturi 25′ at location 41′, increases the turbidity within the column to enhance contact between the liquid and gas mix. The recirculation circuit has the added benefit that it increases the residency time of liquid within the reactor vessel, separately of the speed of the pump 11′. The outlet pipe 31′ is connected to the base of the fractionation column 21′ to remove treated liquid from the reactor vessel 23′ and return it to the holding tank 15′.

Flow rate valves 43′ and 45′ are provided on the main inlet 13′ and outlet 31′ pipes, respectively, to allow for adjustment of throughput.

Whilst this dual pump protein skimmer design is superior to the previous single pump design, in allowing independent control of parameters to achieve maximum operating efficiency, it is not as cost effective as it does require a second pump, which is not inexpensive. In addition, it does require balancing by continual adjustment of the flow rate valves to set the optimum level of liquid within the column, given that the amount of foam produced that is necessary to adsorb biomass thereto, is dependent on the amount of protein in the liquid. Adjustment via the flow rate valves, however, directly affects throughput, which is preferred to be maximised.

In both of these protein skimmer designs, the inlet 13′ from the holding tank 15′ normally consists of a suction pipe. The pipe simply has an open end disposed directly within the holding tank or within a skimmer chamber into which liquid from the holding tank flows to be drawn from the tank for treatment. The protein skimmer is normally intended to supplement a primary filtering or treatment process for liquid within the holding tank, such as a biofilter and simply draws liquid from the same source as the primary filtering or treatment process, without any preliminary filtering or separation stage. Consequently, the protein skimmer can receive large biomass particles, which can be difficult for it to adsorb and float out of the system. This places an extra burden on the efficacy of the protein skimmer and in balancing the system to work efficiently to reduce or remove nitrites and nitrates manifesting themselves as protein at the molecular level, as well as removing suspended solids and solids from the liquid by flotation.

Present types of tank systems for accommodating aquatic species in a closed circuit system, where protein skimmers of the aforementioned kind find particular application, essentially consist of a long tank filled with water in which the aquatic species are disposed, such as is shown in FIG. 1C of the drawings. At one end of the tank A is provided a prefilter B and a biofilter C of known design. At the other end of the tank A is a protein skimmer D and associated pipe circuitry. A rectangular arrangement of water suction lines E are disposed at the base of the tank A and are connected to a pump F via an inlet line G. The pump F in turn is connected to an outlet manifold H via a water outlet line I. The manifold H is provided with a series of nozzles for spraying water, which is sucked from the bottom of the lank via the suction lines E into the prefilter B to pass through the biofilter C. The biofilter C is provided with a pair of discharge pipes J for discharging water filtered by the biofilter back into the holding tank A.

As shown in FIG. 1C, the prefilter B is disposed above the biofilter C, which in turn is disposed above the tank A at the one end thereof.

This prior art tank system has several disadvantages associated with it:

1. The prefilter B is usually neglected because of its elevated position where it is difficult to access.

2. The clean water from the biofilter is discharged into the tank A at one end and due to the arrangement of the suction lines at the base directly below it, creates a vertical water flow which is concentrated at the one end of the tank, short circuiting the flow of water throughout the tank.

3. There is not a uniform flow of clean water discharged into the tank via the discharge pipes J through to the other end of the tank and consequently dead spots are created within the tank.

4. Due to the biofilter size, shape and elevation relative to the tank, a large pump is necessary in order to draw a sufficient volume of water from the bottom of the tank, and deliver it to the prefilter B and biofilter C, so as to keep the biofilter charged with water continuously and the bacteria therein alive, particularly in the off season.

5. In order to clean the biofilter, the pump needs to be switched off and the biofilter drained, thereby killing the active bacteria within the biofilter.

6. There is no area for excess or overflow water from the tank to flow to, if the tank is heavily loaded with product, which is a natural tendency of users of the tank.

7. The tank system is not particularly portable, requiring it to be completely disassembled when transported.

### DISCLOSURE OF THE INVENTION

It is an object of one aspect of the present invention to provide for improving the control of a flotation/fractionation system in a more cost effective and efficient manner than prior art systems of the type as hereinbefore described.

It is an object of another aspect of the present invention to provide for the preliminary separation of particles from a liquid to facilitate its further treatment by a flotation/fractionation system or other means.

In accordance with a first aspect of the present invention, there is provided an improvement in a fractionation/flotation system for removing waste such as biosolids, nitrates or nitrites from a liquid containing same comprising: a fractionation column; a foam aggregation chamber surmounting the fractionation column; a liquid inlet means for inletting liquid containing the waste into the fractionation column; pump means for pumping the liquid through the liquid inlet means; gas injecting means for injecting a waste reducing gas such as air, oxygen or ozone into the liquid immediately prior to inletting the same into the fractionation column; foam extracting means to extract foam collected within the foam aggregation chamber; and liquid outlet means for outletting treated liquid from the base of the fractionation column; the improvement residing in:

the liquid inlet means being divided into:

(a) a first liquid inlet for inletting liquid containing waste at an intermediate location along the axial extent of said fractionation column, said first liquid inlet having a flow regulator to control the flow rate of liquid being inlet into the column thereby; and

(b) a second liquid inlet for simultaneously inletting the liquid containing waste at an intermediate, albeit lower, location along the axial extent of said fractionation column than said first liquid inlet, said second liquid inlet having said gas injecting means disposed in series therein for injecting said waste reducing gas into the liquid of the second liquid inlet immediately prior to inletting same within said fractionation column;

wherein the division occurs after the outlet of said pump means;

and wherein liquid within said fractionation column is able to be maintained at an optimum level to enable foam having waste adsorbed thereto to aggregate in said aggregation chamber by controlling said regulator.

Preferably, the gas injecting means comprises a venturi whereby said waste reducing gas is drawn into the throat of the venturi to permeate and aerate the liquid containing waste passing through the venturi.

Preferably, the waste reducing gas is a mix of oxygen and ozone.

In accordance with a second aspect of the present invention, there is provided an improved method for controlling the removal of waste such as biosolids, nitrates or nitrites from a liquid containing same using a fractionation/flotation system comprising: a fractionation column; a foam aggregation chamber surmounting the fractionation column; foam extracting means to extract foam collected within the foam aggregation chamber; and liquid outlet means for outletting treated liquid from the base of the fractionation column; the method comprising:

inletting liquid containing waste under pressure into the fractionation column at first and second intermediate locations from a common source, the second location being lower than the first location;

injecting a waste reducing gas such as air, oxygen or ozone into the liquid immediately prior to inletting the same into the fractionation column at the second intermediate location; and

regulating the flow of liquid being inlet at the first intermediate location to maintain the liquid within the fractionation column at an optimum level for enabling foam having waste adsorbed thereto to aggregate in the aggregation chamber.

Preferably, the waste reducing gas is a mix of oxygen and ozone.

In accordance with a third aspect of the present invention, there is provided an apparatus for separating liquid containing particles of varying mass or specific gravity comprising:

an elongated passageway having: (a) a leading wall with a primary lip for liquid containing said particles to flow over into said passageway; (b) a trailing wall with secondary lip disposed lower than said primary for liquid to flow over and out of said passageway; and (c) a base closing the bottom of said passageway to enable the liquid flowing into the passageway over said primary lip to fill the same and flow out over the secondary lip;

flow diverting means disposed in said passageway for diverting the liquid flow therein to create a convolving recirculating portion of laminar flow and a discharging portion of laminar flow of liquid within the passageway; and

liquid extraction means to extract liquid containing particles of lower mass or specific gravity entrained within said recirculating portion therefrom, leaving liquid containing particles of waste to flow out of said passageway and over the secondary lip.

Preferably, said flow diverting means comprises a circular pipe disposed in parallel and spaced relationship to the longitudinal extent of the walls and base.

Preferably, said liquid extracting means comprises a plurality of rectilinearly aligned holes disposed axially along the suction pipe at spaced apart locations and suction means to apply a negative pressure to the inside of the circular pipe to draw liquid from said recirculating portion.

Preferably, the prefilter includes a solids extracting means having an inlet confronting the cascading flow to extract solids retained therein.

Preferably, said liquid extraction means is connected to the inlet of a fractionation/flotation system for removing waste including said particles entrained within the extracted liquid therefrom.

Preferably, said fractionation/flotation system is as defined in any one of the preceding aspects of the present invention.

In accordance with a fourth aspect of the present invention there is provided a method for separating liquid containing particles of varying mass or specific gravity comprising:

cascading liquid containing said particles over a primary lip into a passageway;

diverting the flow of the liquid within the passageway to create a convolving recirculating portion of laminar flow and a discharging portion of laminar flow;

extracting liquid containing particles of lower mass or specific gravity entrained within said recirculating portion therefrom; and

discharging liquid containing particles of higher mass or specific gravity entrained within said discharging portion out of said passageway over a secondary lip.

It is an object of a further aspect of the present invention to provide for a more efficient and effective tank system for accommodating aquatic life than the type of prior art tank system described above.

It is a preferred object of this further aspect of the invention to provide for a uniform cross-flow of fluid in a tank system for the purposes of accommodating aquatic life therein.

In accordance with a fifth aspect of the present invention, there is provided a tank system for accommodating aquatic life comprising:

a holding tank for holding fluid to sustain aquatic life disposed therein;

a filtering means for receiving extraneous fluid from the holding tank at one end of a filtering area and allowing the fluid to gravitate through a filtering medium disposed within the filtering area to another end of the filtering area;

tank discharge means to provide for the discharge and passage of the extraneous fluid from the top of the holding tank, along the substantial longitudinal extent of one side thereof, to the top of the filtering area at said one end thereof;

recirculating means for recirculating the extraneous fluid passed through the filtering means, from the other end of said filtering area to the holding tank, the recirculating means including tank inlet means for inletting fluid under pressure from the filtering means into the holding tank; and

said filtering means being disposed adjacent to the holding tank and the tank discharge means allowing for the natural flow of fluid from the top of the holding tank adjacent to said one side, to the top of the filtering area;

wherein the tank inlet means is disposed at the base of the holding tank, spaced from, and extending generally parallel, to the discharge means to provide for a uniform, circulatory cross-flow of fluid about a generally horizontal axis in substantially parallel relationship to said one side and to said tank inlet means, along the longitudinal extent of the holding tank and the tank discharge means.

Preferably, the tank inlet means has a rectilinear arrangement of insetting nozzles for jetting fluid into said holding tank extending longitudinally thereof, whereby said rectilinear arrangement of insetting nozzles is disposed to be marginally offset from true parallel relationship with said horizontal axis to generate a latent axial flow of fluid relative to said horizontal axis within said holding tank, directing said cross-flow spirally about the central longitudinal axis of the holding tank.

Preferably, the holding tank is provided with opposing end walls, one at each end of said tank inlet means, said walls providing a surface to reflect the latent axial flow of fluid along said holding tank, thereby generating transversely and vertically directed eddy currents at axially spaced apart locations along the surface of said holding tank to focus cross-flow of fluid carrying suspended solids to the top of said holding tank and towards said one side, between successive eddy currents.

Preferably, a plurality of holding tank modules are disposed in sequential and longitudinally contiguous relationship with each other to define a continuous passage between the holding tank modules, whereby fluid in one holding tank module can flow without restriction to an adjacent holding tank module, and vice versa, and wherein said tank inlet means within adjacent holding tank modules is alternately arranged so that said latent axial flow of fluid in one said holding tank module is opposingly directed relative to said latent axial flow of fluid in an adjacent said holding tank module, thereby generating transversely and vertically directed eddy currents at axially spaced apart locations along the surface of each said holding tank module to focus cross-flow of fluid carrying suspended solids to the top of respective said holding tanks and towards said one side thereof between successive eddy currents.

Preferably, the system includes a buffer tank communicating with the filtering means and being connected to said recirculating means separately of said filtering means to supply fluid for inletting into said holding tank separately of said filtering means, thereby providing a separate and parallel flow of fluid to the flow of fluid through said filtering means, said buffer tank having sufficient headroom to receive and accommodate a sudden oversupply of fluid from said holding tank into said filtering means whilst still maintaining a fluid level within said filtering area, said buffer tank being of a height less than the height of the filtering area to prevent a backflow of fluid beyond a prescribed threshold level.

Preferably, the tank discharge means includes a partition to maintain separation of the contents of the holding tank and the filtering means, and a primary lip at the top of the partition, whereby extraneous fluid from the holding tank is permitted to cascade over the primary lip and subsequently pass down through the filtering means.

Preferably, the filtering means includes a prefilter disposed adjacent to the primary lip for extracting solids from the fluid on it cascading over the primary lip prior to passing through to the filtering means, the prefilter including:

(i) a chamber for receiving and expelling liquid from the cascading flow of liquid having an anterior wall surmounted by said primary lip, a posterior wall spaced therefrom surmounted by a secondary lip and a bottom; and

(ii) a suction pipe disposed longitudinally within said chamber in parallel spaced relationship to said walls having a series of inlet holes to extract some of the liquid with entrained solids therein from said chamber.

Preferably, the prefilter includes a flow diverting means to divert and reverse the flow of fluid from the cascading flow over the primary lip so that a reversing and opposing fluid flow is created adjacent the cascading flow from the primary lip so that a reversing and opposing fluid flow is created adjacent the cascading flow from said primary lip and upwardly along the posterior wall of said chamber. In this manner, the reversing liquid flow acts to retain solids in the cascading flow for subsequent extraction.

Preferably, the series of holes are disposed on the surface of said suction pipe at a position to confront the cascading flow to facilitate extracting solids retained therein.

Preferably, the the relative height of the secondary lip is less than the height of the primary lip so as to facilitate subsequent cascading of the reversing fluid flow over the secondary lip and into the one end of the filtering means.

In accordance with a sixth aspect of the present invention, there is provided a tank system for accommodating aquatic life comprising:

a holding tank for holding fluid to sustain aquatic life disposed therein;

a filtering means for receiving extraneous fluid from said holding tank at one end of a filtering area and allowing the fluid to pass through a filtering medium disposed within the filtering area to another end of the filtering area;

tank discharge means to provide for the discharge and passage of the extraneous fluid from said holding tank to the top of said filtering means;

recirculating means for recirculating the extraneous fluid passed through said filtering means, from proximate the bottom of said filtering means to said holding tank;

said filtering means being adjacent to said holding tank and said tank discharge means allowing for the natural flow of fluid from the top of said holding tank adjacent to said one side, to the top of said filtering area; and

a buffer tank being adapted to communicate with said filtering means to provide for a common supply of fluid therebetween;

wherein said buffer tank is connected to said recirculating means separately of said filtering means to supply fluid for inletting into said holding tank separately of said filtering means, thereby providing a separate and parallel flow of fluid to the flow of fluid through said filtering means, said buffer tank having sufficient headroom to receive and accommodate a sudden oversupply of fluid from said holding tank into said filtering means whilst still maintaining a fluid level within said filtering area, said buffer tank being of a height less than the height of the filtering area to prevent a backflow of fluid beyond a prescribed threshold level.

In accordance with a seventh aspect of the present invention, there is provided a method for accommodating aquatic life, comprising:

discharging fluid from the top and along the substantial longitudinal extent of one side of a holding tank filled with fluid in which aquatic life may be disposed;

filtering out impurities from the discharged fluid whilst gravitating through a filtering area;

recirculating filtered fluid to the bottom of the holding tank; and

inletting the recirculated filtered fluid into the tank under pressure at a position spaced from and generally parallel to where the fluid is discharged from the holding tank, so that a uniform, circulatory cross-flow of fluid is created along the longitudinal extent of the holding tank about a generally horizontal axis in substantially parallel relationship to said one side.

Preferably, the method includes inletting recirculated fluid into the holding tank from directly below where fluid is discharged, at an oblique angle relative to the horizontal and vertical, upwardly and transversely across said holding tank in a direction to promote said circulatory cross-flow of fluid.

Preferably, the method includes inletting recirculated fluid into the holding tank from a diagonally opposed position to where fluid is discharged, at an oblique angle relative to the horizontal and vertical, upwardly and transversely across said holding tank, in a direction to promote said circulatory cross-flow of fluid.

Preferably, the method includes directing fluid with more of a horizontal component from the position below from where fluid is discharged than in the case of directing fluid from the diagonally opposed position to where the fluid is discharged.

In accordance with an eighth aspect of the present invention, there is provided a method for accommodating aquatic life, comprising:

discharging fluid from the top of a holding tank filled with fluid in which aquatic life may be disposed;

filtering out impurities from the discharged fluid whilst gravitating through a filtering area;

recirculating filtered fluid to the bottom of the holding tank;

recirculating a separate and parallel flow of filtered fluid after filtering from the filtering area to the holding tank via a buffer tank;

automatically channelling excessive fluid out during the filtering and recirculating steps into said buffer tank when a sudden oversupply of fluid is discharged from said holding tank for filtering, thereby maintaining a fluid level within the filtering area at a prescribed threshold level; and

automatically feeding the excessive fluid back during the filtering and recirculating steps, as the excessive discharge volumes are diminished.

### BRIEF DESCRIPTION OF THE DRAWINGS

FIG. 1A is a schematic drawing of a known design for a protein skimmer which is characterised by a single pump and inlet;

FIG. 1B is a schematic drawing of another known design for a protein skimmer which is characterised by a dual pump arrangement and recirculation circuit;

FIG. 1C is an isometric schematic diagram of a typical prior art tank system;

FIG. 2 is a perspective view of a tank system for aquatic species;

FIG. 3 is a plan view of FIG. 2;

FIG. 4 is an end elevation of the tank system shown in FIGS. 2 and 3, taken from the services end of the tank and showing the plumbing arrangement of the piping for the protein skimmer and tank system generally in schematic form;

FIG. 5 is a cross-sectional view of the tank system taken along section B-B of FIG. 3;

FIG. 6 is a cross-sectional view of the particle separator;

FIG. 7 is a schematic diagram showing the principle of operation of the improved protein skimmer design utilising the invention; and

FIG. 8 is an exploded view of the actual protein skimmer design in accordance with the embodiment.

FIG. 9 is a plan view of a tank system in accordance with the second embodiment;

FIG. 10 is a side elevation of the tank system taken along section A-A of FIG. 9;

FIG. 11 is an end elevation of the tank system shown in FIGS. 9 and 10, taken from the services end of the tank;

FIG. 12 is a cross-sectional end view of the tank system taken along section B-B of FIG. 9;

FIG. 13 is a schematic isometric view of the holding tank of the second embodiment showing the uniform circulatory cross-flow of fluid and the location of ephemeral eddy currents as a result of the latent axial flow of fluid and reflection of same within the holding tank;

FIG. 14 is a schematic side elevation of the holding tank of the second embodiment showing the spiralling effect of the latent axial flow of fluid relative to the horizontal axis about which the uniform, circulatory cross-flow of fluid is created;

FIG. 15 is a schematic isometric view showing the location of three tank systems operated in parallel to each other, in accordance with the second embodiment;

FIG. 16 is a cross sectional end view of the three tanks as shown in FIG. 15;

FIG. 17 is a schematic cross sectional elevation of a smaller version display and research tank system in accordance with the third embodiment;

FIG. 18 is a plan view of FIG. 17;

FIG. 19 is a similar view to FIG. 18 but showing the lids in place;

FIG. 20 is a schematic side elevation showing the relative dimensions of the tank system and the arrangement of certain elements thereof in accordance with the third embodiment;

FIG. 21 is a set of orthographically projected views of a biofilter element for use in the biofilter of a smaller tank system as described in the second embodiment, wherein:

FIG. 21a is a side elevation of the rear of the element;

FIG. 21b is a cross sectional end elevation of the element;

FIG. 21c is a plan view of the element;

FIG. 21d is a side elevation of the front of the element;

FIG. 22 is a schematic side view of the tank system similar to that of FIG. 20, but viewed as of the other side of the tank;

FIG. 23 is a similar view to FIG. 20, but showing more detail;

FIG. 24 is a schematic plan view showing the arrangement of the primary filtration system and the holding water recirculation system in accordance with a particular arrangement of the third embodiment;

FIG. 25 is an end view of an alternative tank system in accordance with fourth embodiment for displaying and holding shellfish in holding tanks disposed on either side of the biofilter;

FIG. 26 is a cross sectional plan view of the tank system of FIG. 25 as viewed from beneath the holding tanks;

FIG. 27 is a side elevation of FIGS. 25 and 26;

FIG. 28 is a similar view as to FIG. 26 but viewing the holding tanks from the top;.

FIG. 29 is an isometric view of a rectilinear tank system in accordance with a fifth embodiment;

FIG. 30 is a plan view of FIG. 29;

FIG. 31 is a side elevation of FIGS. 29 and 30;

FIG. 32 is a perspective view of a regular annular tank system in accordance with a sixth embodiment;

FIG. 33 is a plan view of FIG. 32;

FIG. 34 is a perspective view of an elongated annular tank system in accordance with an seventh embodiment;

FIG. 35 is a plan view of FIG. 34;

FIG. 36 is a plan view of a zig-zag rectilinear tank system in accordance with a eighth embodiment; and

FIG. 37 is a plan view of a convoluted tank system in accordance with an ninth embodiment.

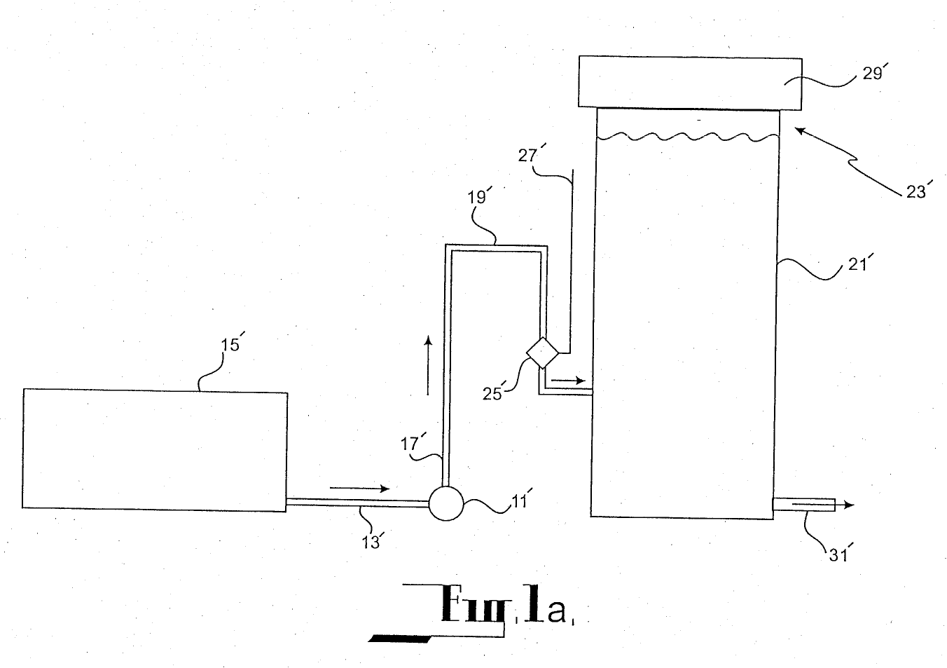

### BEST MODE(S) FOR CARRYING OUT THE INVENTION

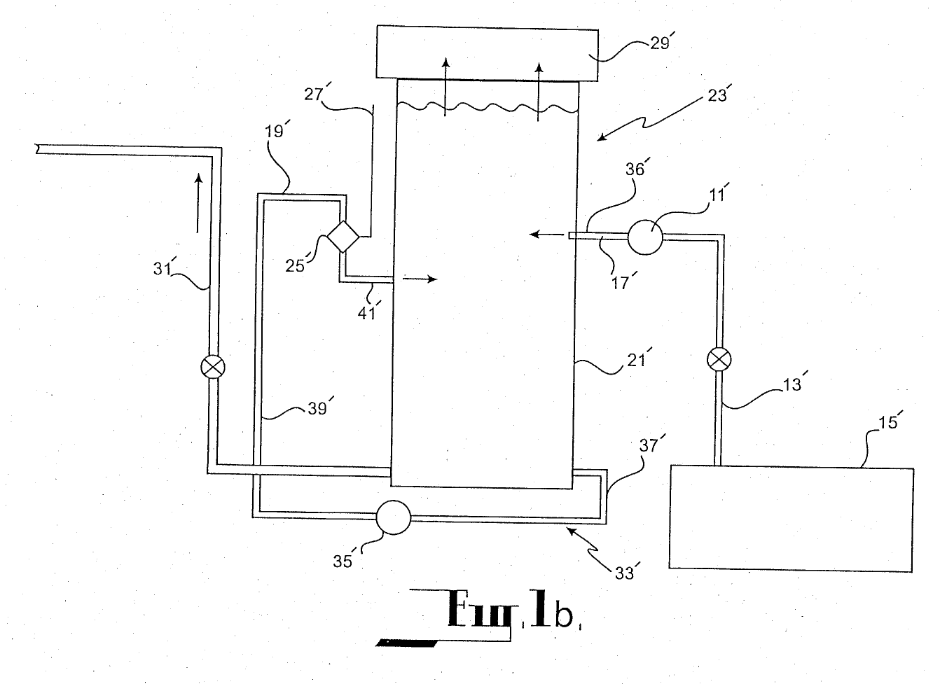

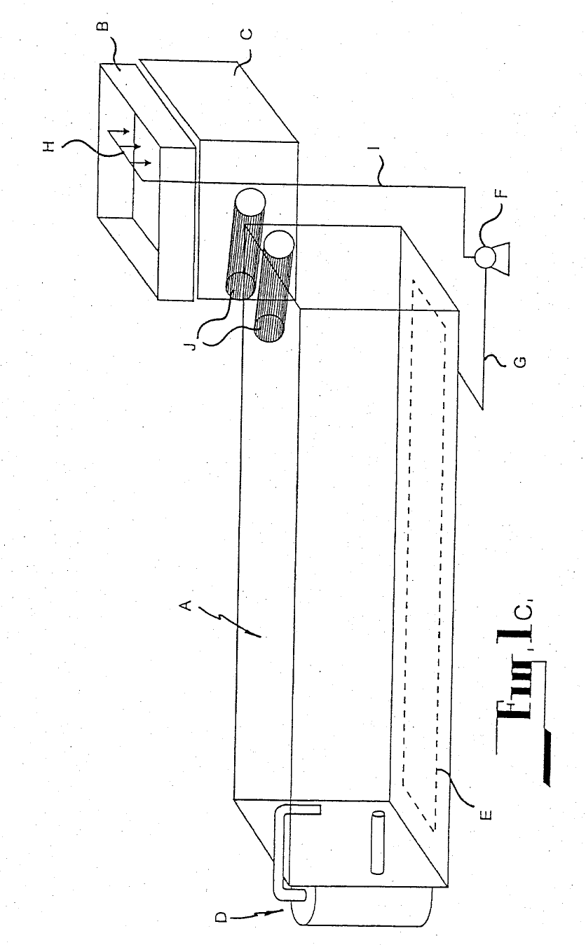

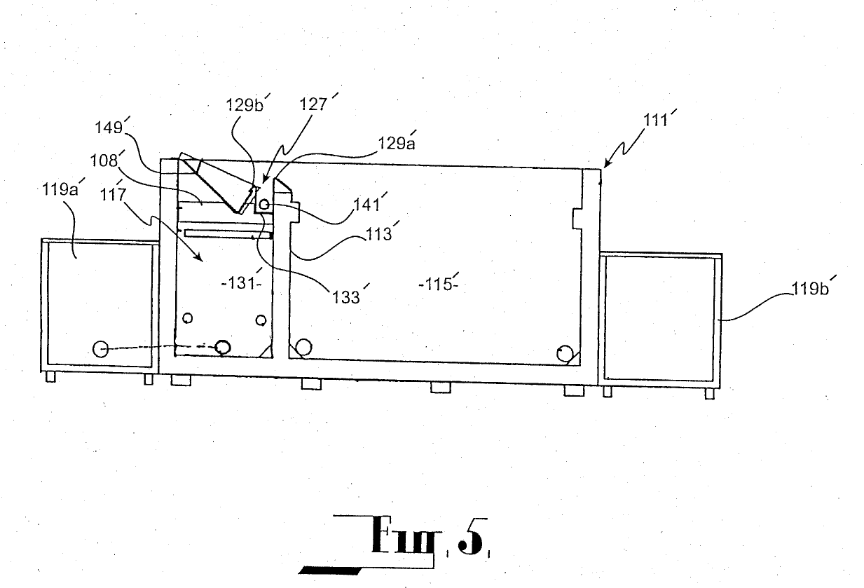

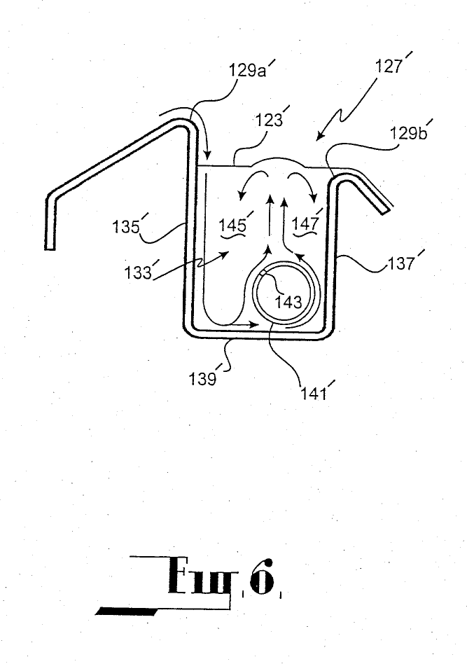

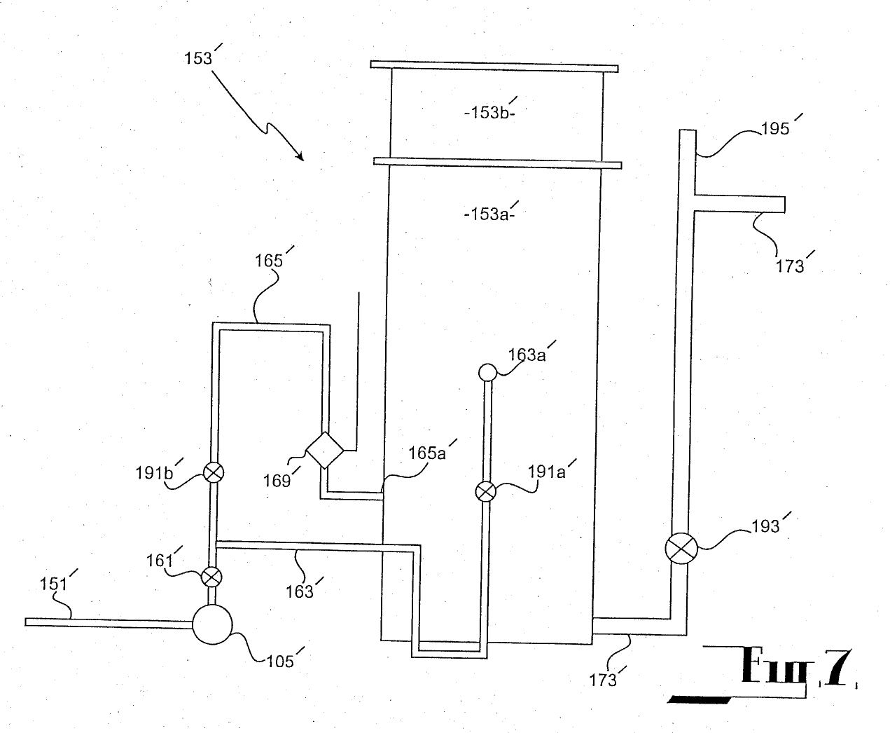

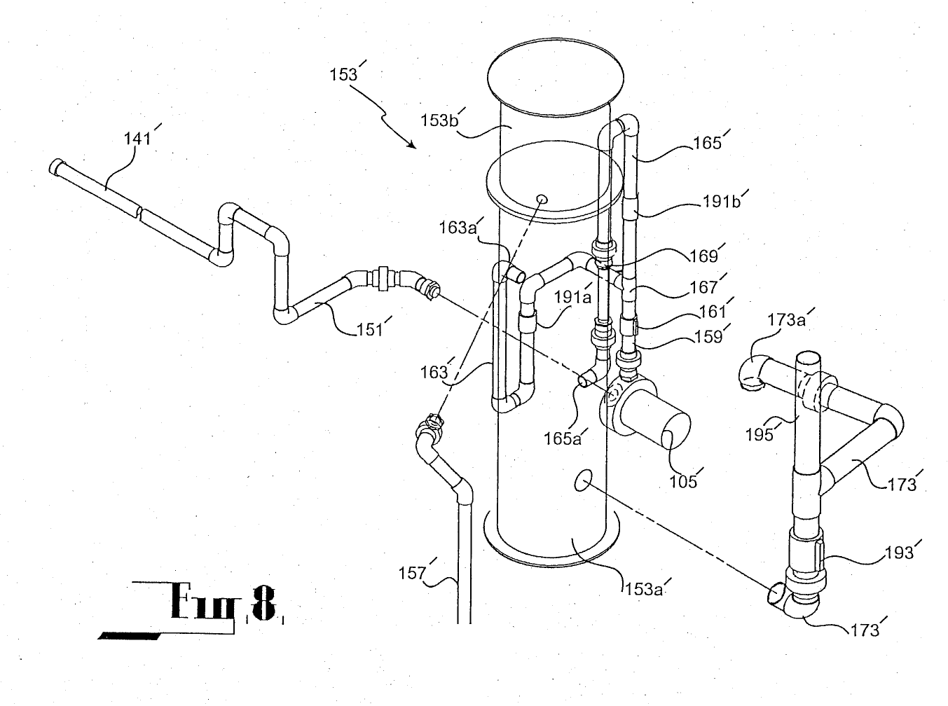

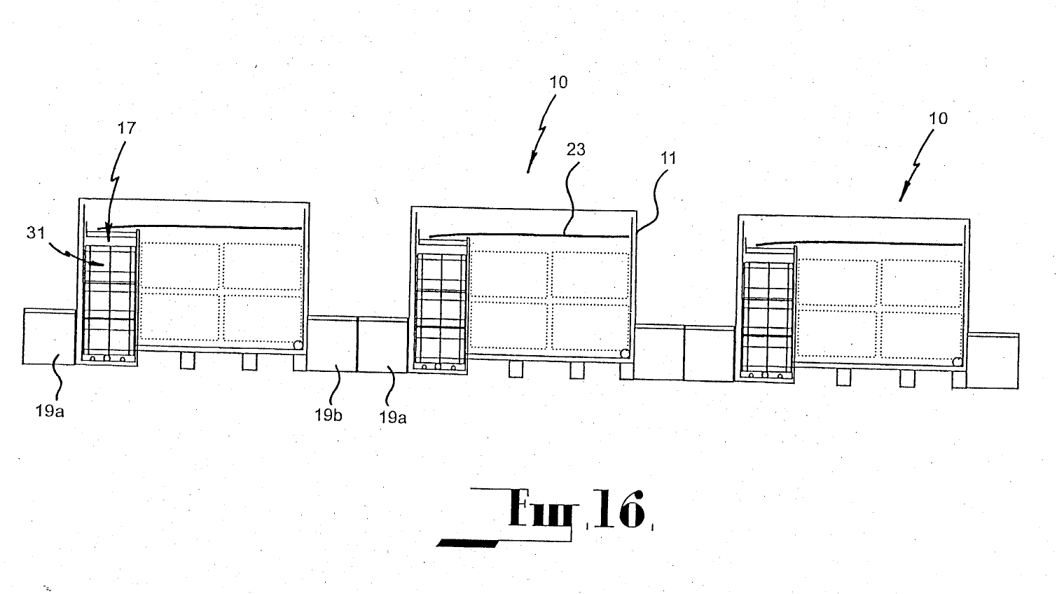

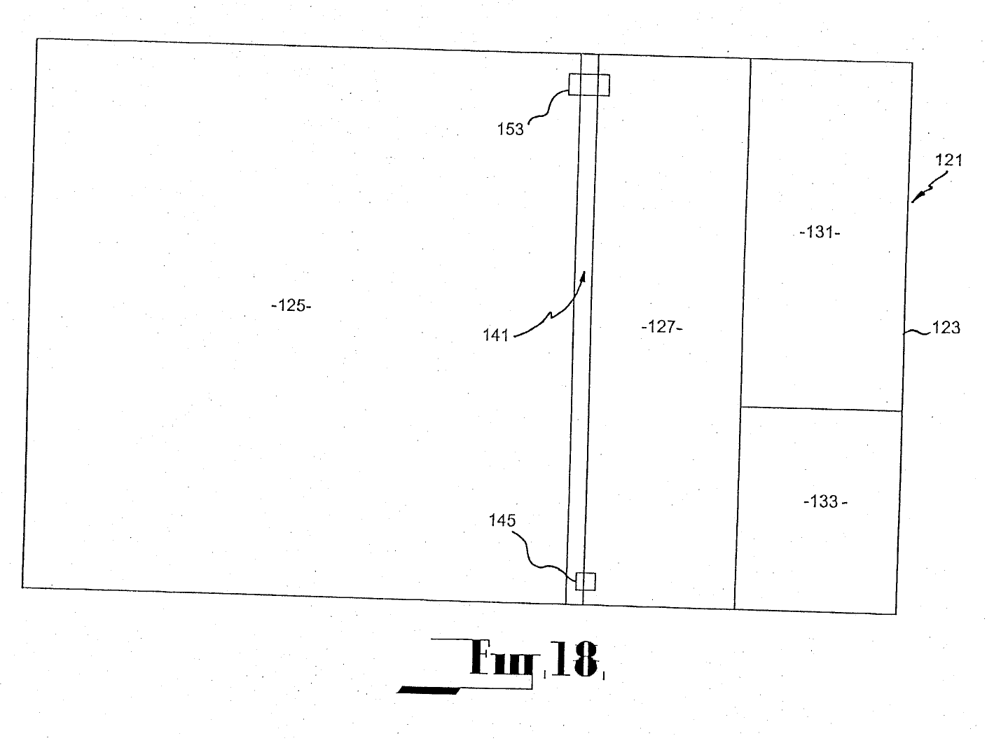

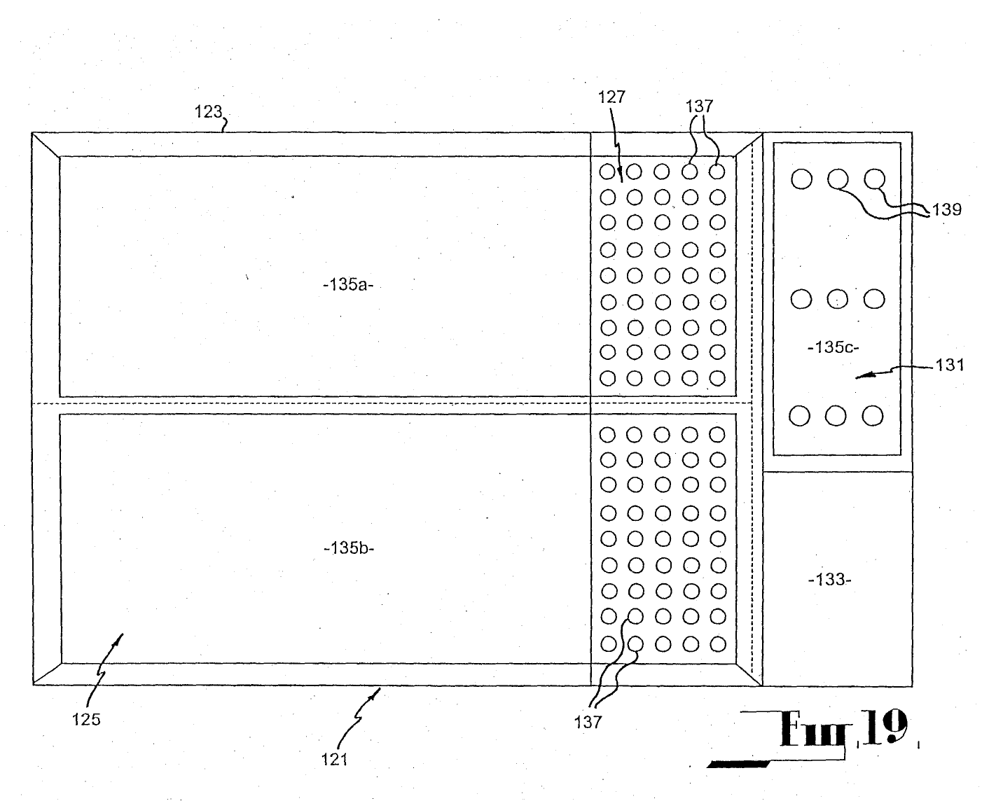

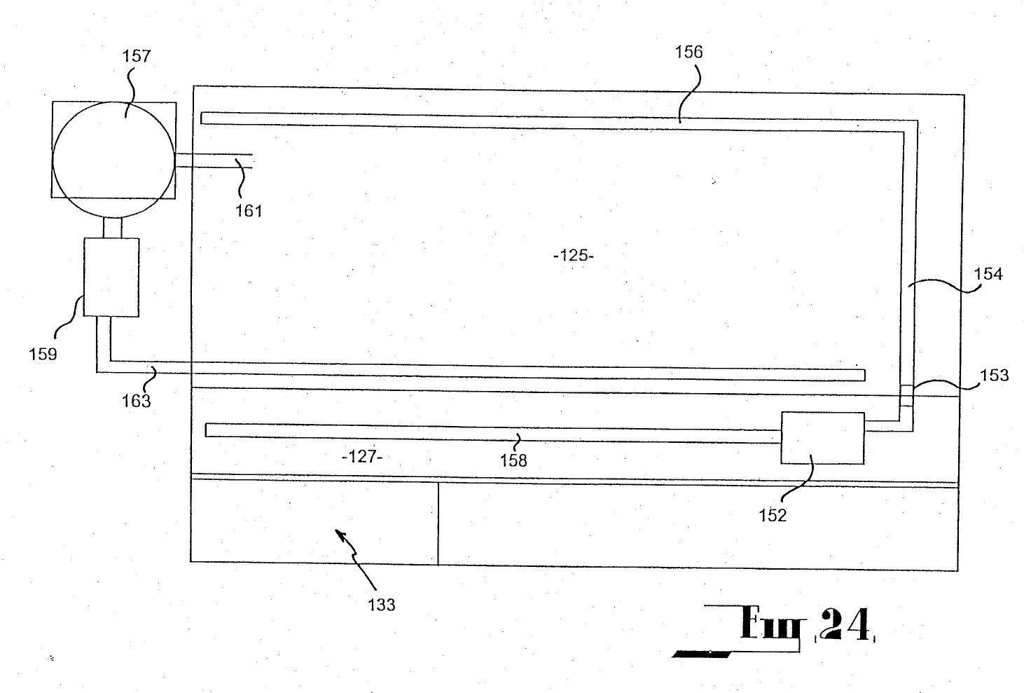

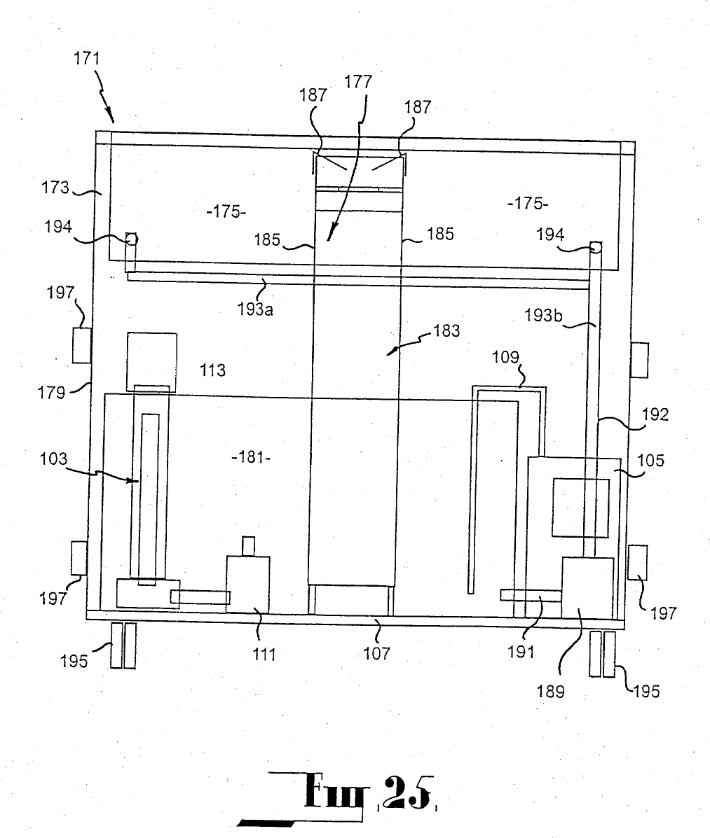

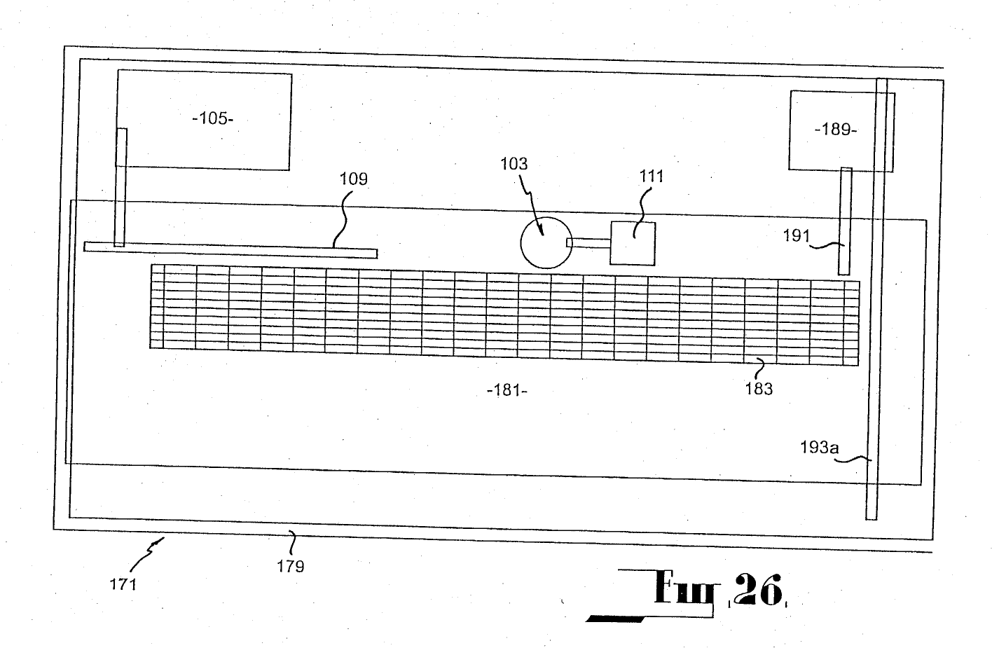

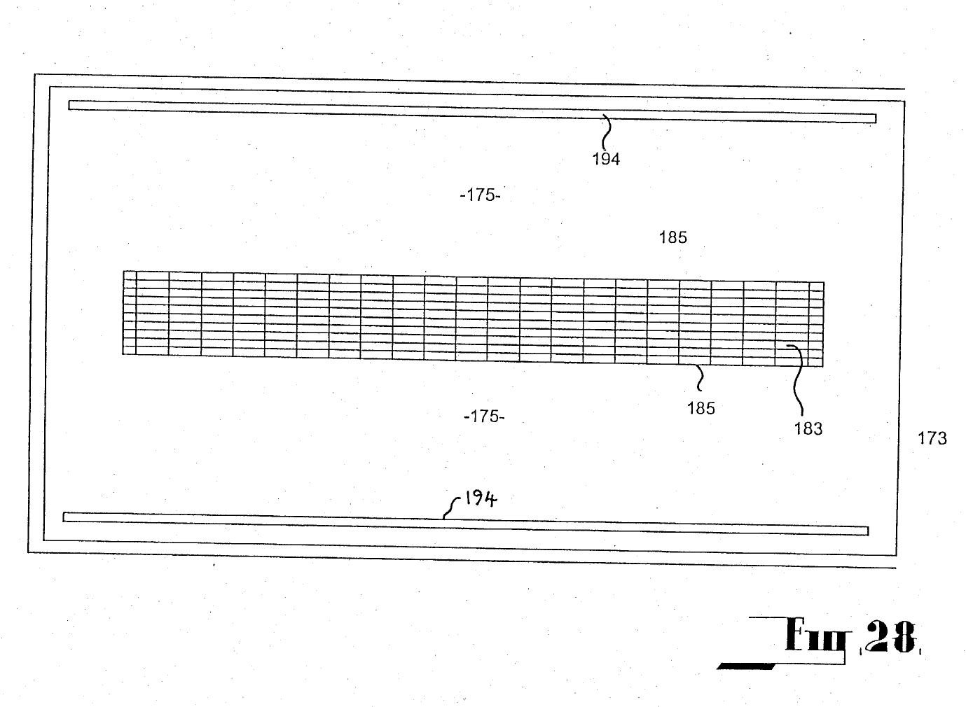

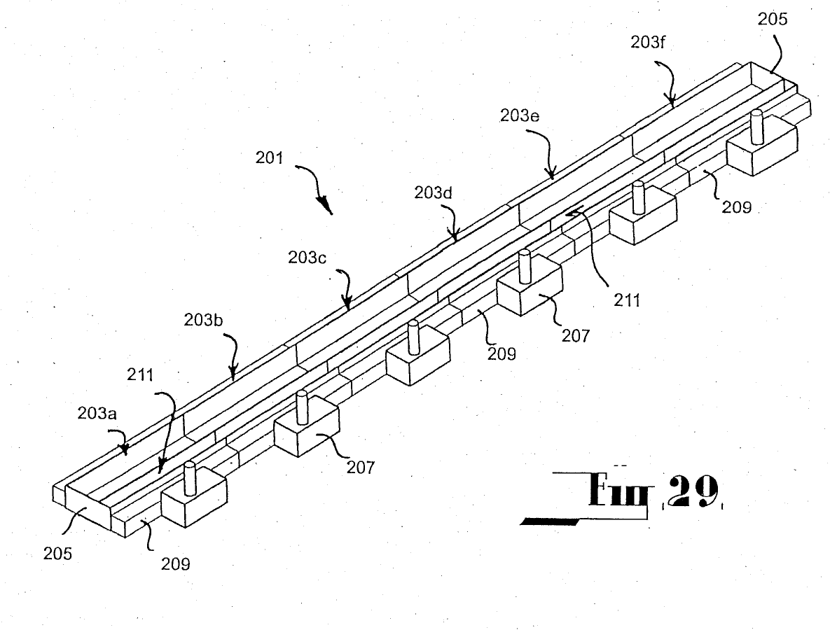

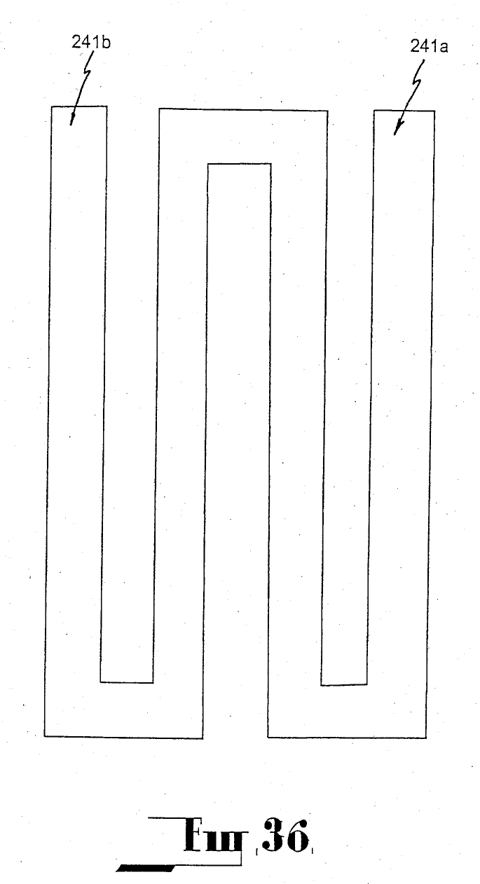

The best mode for carrying out certain aspects of the present invention is described with reference to FIGS. 2 to 8, wherein the invention is embodied in a tank system for aquatic species that is sufficiently large to efficiently handle volumes of fish on a relatively large scale for commercial purposes. The tank system is substantially described in the applicant's corresponding International Patent Application PCT/AU00/00800, which is incorporated herein by reference. The embodiments of the tank system described in International Patent Application. PCT/AU00/00800 embody other aspects of the present invention, which in themselves constitute other modes for carrying out the invention. Accordingly, these embodiments are also described herein with reference to FIGS. 9 to 37. As shown in FIGS. 2 to 5, the tank system 101′ comprises a large main tank 111′ that is divided into a holding tank 115′ and a filtering means area 117′ by an inner partition 113′. A pair of longitudinally extending buffer tanks 119a′ and 119b′ is provided so that one buffer tank is disposed on either longitudinal side of the main tank 111′.

The tank system 101′ includes a main services area 103′ at one end thereof, which accommodates the main operating components of the tank. These include:

a pair of main pumps 121a′ and 121b′ connected by a network of pipes on the inlet side to the respective buffer tanks 119a′ and 119b′ and the filtering means area 117′, and by corresponding pipes on the outlet side to the main tank 111′ for recirculating fluid throughout the main tank 111′ via the buffer tanks and filtering means;

a supplementary filtering means in the form of a protein skimmer 125′, which comprises a foam flotation/fractionation system to treat liquid containing waste such as biosolids, nitrites and nitrates is connected via an auxiliary pump 105′ to a suction pipe 141 of a liquid and particle separator 127′;

a discharge chamber 155′, which is supplied with fluid outlet from the protein skimmer 125′ via an outlet pipe 173′, for discharging ozone and other gases entrained into the water by the protein skimmer during flotation/fractionation process;

a fluid cooler means in the form of refrigeration system including a cooler or evaporative coil 175′ disposed in the discharge chamber 155′, a condenser (not shown) and a compressor (not shown); and

an air compressor 156′ which is connected to an outlet pipe 159′ disposed along the bottom of the filtering means area 117′.

The main pumps 121′, protein skimmer 125′ and fluid cooler means are all disposed at one end of the system 101′, adjacent to the end wall 11a′ of the main tank, in a separate services compartment.

The inner partition 113′ maintains separation of the contents of the holding tank 115′ and the filtering means area 117′ and has a tank discharge means surmounted thereon. The tank discharge means incorporates the liquid and particle separator 127′, which includes a primary lip 129a′ and a secondary lip 129b′ over which liquid flows. The liquid and particle separator 127′ separates liquid containing waste particles dependent upon the mass or specific gravity of the particles. By virtue of this arrangement liquid containing relatively low mass or specific gravity may be treated by the protein skimmer 125′ and liquid containing particles with a higher mass or specific gravity may be passed through the tank discharge means and over to the main filtering means 117′. The separator 127′ will be described in more detail later.

Thus the tank discharge means effectively provides a knife edge by virtue of the primary lip 129a′ over which water may cascade and a sequential flow path through the separator 127′ to direct fluid to either the protein skimmer 125′ or the middle of the filtering means area 117′, over the secondary lip 129b′ and a ‘v’ shaped upper drip tray 149′.

Filtering means in the form of a biofilter 131′ is disposed in the area 117′. The biofilter 131′ is of known design, consisting of a biomass comprising a multitude of bioballs within which active bacteria may grow.

The bacteria feeds on and thus cleans water and fluid flowing through the biofilter of ammonia and nitrite, which is excreted by the shellfish or other aquatic animals contained within the holding tank. Thus, the biofilter 131′ performs an important filtering and cleansing function for the water 123′ contained within the holding tank portion 115′ when live shellfish is disposed therein.

In the present embodiment the continuous flow of water from the holding tank 115′ to the filtering means area 117′ is provided by filling the holding tank with sufficient water 123′ to allow it to continuously cascade over the primary lip 129a′. Thus, the discharge means relies upon discharging water 123′ from the holding tank 115′ in a continuous flow from the top of the holding tank 115′, immediately adjacent to the primary lip 129a′ of the tank discharge means.

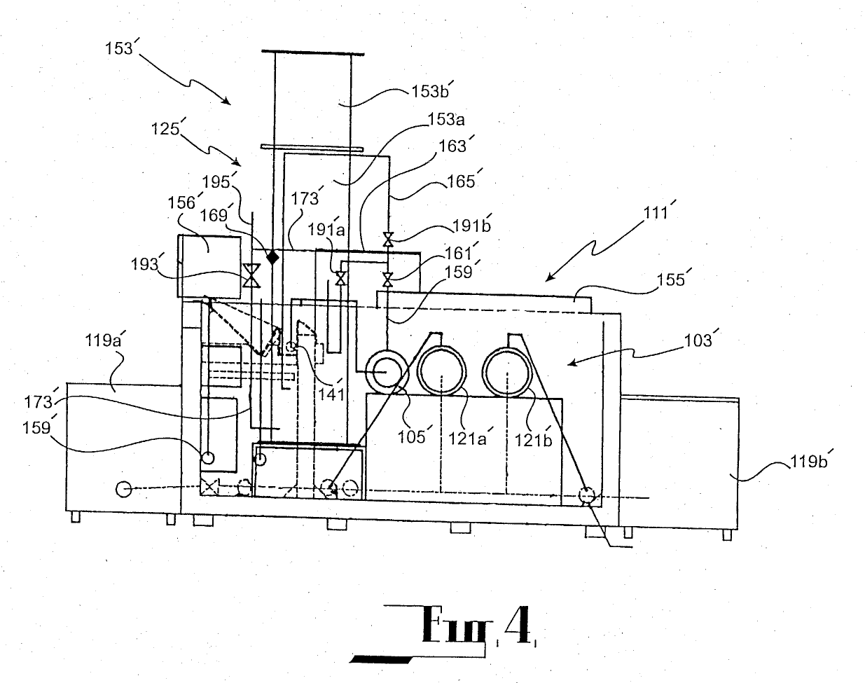

Now describing the liquid and particle separator 127′ in more detail, as shown in FIG. 6 of the drawings, the separator comprises an elongated passageway 133′ defined by a leading wall 135′ having the primary lip 129a′ disposed at the top thereof, a trailing wall 137′ having the secondary lip 129b′ disposed at the top thereof and a base 139′ closing the bottom of the passageway to enable the liquid flowing into the passageway over said primary lip 129a′ to fill the same and flow out over the secondary lip 129b′.

The suction pipe 141′ is disposed within the passageway 133′ in parallel and spaced relationship to the longitudinal extent of the walls 135′, 137′ and the base 139′, closer to the base and the trailing wall 137′ than the to the leading wall 135′ and the lips 129′. The pipe 141′ is circular in cross-section and functions as a flow diverting means and a liquid and particle extraction means. The flow diversion is provided by the shape and positioning of the pipe within the passageway 133′. The liquid and particle extraction, on the other hand, is provided by a series of rectilinearly aligned holes 143′ disposed axially along the pipe 141′ at spaced apart locations and suction means provided by the auxiliary pump 105′ to apply a negative pressure to the inside of the circular pipe to draw in liquid from the passageway. The holes 143′ are disposed in the half of the pipe 141′ confronting the leading wall 135′ and further in the upper quartile of this half at an angle of approximately 45° from the vertical.

The positioning of the suction pipe 141′ relative to the walls and base of the passageway 133′ is important in diverting flow into a convolving recirculating portion 145′ of laminar flow and a discharging portion 147′ of laminar flow within the passageway. This separation of flow essentially allows liquid entrained with biosolids of relatively high mass or specific gravity to be diverted around the rear of the suction pipe 141′ and into the discharging portion 147′ of the laminar flow. Once in this portion of the flow, these higher mass biosolids will flow out of the passageway 133′ and over the secondary lip 129b′ into the drip tray 149′. On the other hand, liquid entrained with biosolids of a lower mass or specific gravity will tend to be diverted into the recirculating portion 145′ of flow, where the positioning of the holes 143′ in the recirculating portion of the flow, extracts this liquid with its entrained biosolids and waste from the passageway 133′ and directs it to the protein skimmer 125′.

The spacing of the holes 143′ is relatively close, for example, at 50 millimetre intervals at the end of the pipe 141′ farthest from the services end 103′ of the tank system, and gradually increasing in spacing to, for example 200 millimetres apart at the proximal end of the pipe to the services end 103′. The inlet holes are typically of a diameter of 8 millimetres, however all of these dimensions may vary, depending upon the particular flow rate of the water through the separator 127′ desired to be achieved and the particular type of aquatic species that is accommodated within the main tank 111′.

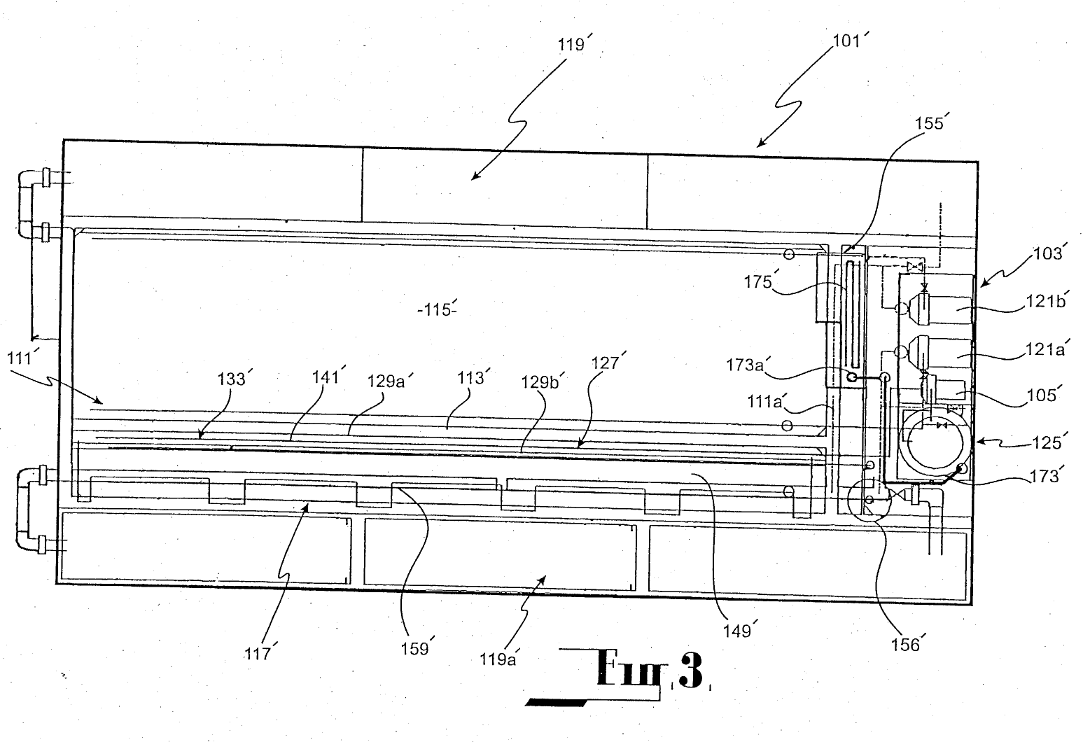

The separator 127′ is disposed immediately adjacent to the ‘v-shaped’ upper drip tray 149′, which accommodates a replaceable water permeable mat (not shown) therein. The upper drip tray 149′ is positioned so that the anterior side of the ‘v’ is contiguous with the posterior side of the secondary lip 129b′, whereby the extracting portion of the laminar flow of water cascades over the secondary lip and onto the mat. As shown in FIG. 5 of the drawings, the posterior of the secondary lip 129b′ forms a flap which surmounts the mat and the anterior side 149a′ of the tray.

The passageway 133′ and the tray 149′ are supported in position by a plurality of cross-braces 108′ which transversely span the top of the filtering means area 117′. Each cross-brace 108′ is fixed at one end to the partition 113′ and at the other end to the outer side wall 111a′ of the main tank 111′. The top of each cross-brace 108′ is particularly configured so as to define a rectangular recess adjacent to the partition 113′ to seat the passageway 133′ therein and a ‘v-shape’ recess intermediate the remaining portion of the brace, closer to the side wall 111a′ to seat the upper tray 149′ therein.

The protein skimmer 125′ is part of a separate treatment circuit for the liquid to supplement the filtering function of the biofilter 131′. Moreover, the protein skimmer 125′ functions to remove waste material such as suspended biosolids, nitrates and nitrites from the holding tank. This waste is created by shellfish excrement, parts or the like, and is in solution such as protein as well as in suspension. The protein skimmer thus performs a supplementary filtering and cleansing action to the biofilter.

The protein skimmer 125′ operates by sucking liquid and waste particles from the passageway 133′ via the suction pipe 141′ and an inlet line 151′ connected thereto, to the auxiliary pump 105′, as previously described. This liquid containing waste is then pumped via a liquid inlet means to a reactor vessel 153′ comprising a fractionation column 153a′ surmounted by an aggregation chamber 153b′. The liquid is injected with an ozone and oxygen gas mix and waste to reduce and neutralize the nitrite and nitrate components and biomass is adsorbed to foam formed at the gas—liquid interface to be floated off and collected within the aggregation chamber 153b′. In this manner, the liquid is fractionated so that the treated liquid gravitates to the bottom of the fractionation column 153a′ from where it is returned to the holding tank via suitable return means.

The foam containing entrained protein and solids that is collected in the aggregation chamber 153b′ is outlet via a foam outlet pipe 157′ periodically for subsequent disposal.

The injection of ozone through the water not only promotes the foam flotation/fractionation process but also provides a filtering of nitrates and nitrites from the water, which can be harmful to the aquatic species.

An important aspect of the present embodiment is the particular arrangement of the liquid inlet means between the pump 105′ and the fractionation column 153a′. The liquid inlet means essentially comprises a branching circuit connected to an outlet line 159′ from the pump 105′. This outlet line includes a flow regulator valve 161′ and is connected to a first liquid inlet line 163′ and a second liquid inlet line 165′ via a coupling 167′. The outlet lines 163′ and 165′ inlet liquid containing waste at intermediate locations along the axial extent of the fractionation column 153a′. The intermediate location 163a′ for the first liquid inlet line 163′ is at a higher position than the intermediate location 165a′ for the second liquid inlet line 165′.

Flow control valves 191′ are connected to each of the branches of the branching circuit so that a flow regulator valve 191a′ is provided along the inlet line 163′, and a flow regulator valve 191b′ is provided along the inlet line 165′, in addition to the flow regulator valve 161′ of the outlet 159′ of the auxiliary pump 105′. A gas injecting means in the form of a venturi 169′ is incorporated into the inlet line 165′ for introducing a waste reducing gas, which in the present embodiment is an ozone and oxygen gas mix, into the liquid containing waste, immediately prior to entering the fractionation column 153a′ at the lower intermediate location 165a′.

The outlet side of the protein skimmer comprises an outlet pipe 173′ which is connected to the outlet of the fractionation column 153′, proximate to the bottom thereof, and directs treated liquid to the discharge chamber 155′. The outlet pipe 173′ is also provided with a control valve 193′ and a vent 195′ to control the outlet flow of fluid from the fractionation column 153a′ and to vent gases such as ozone and oxygen introduced into the water during the flotation/fractionation process, on its way to the discharge chamber 155′. The distal end 173a′ of the outlet pipe discharges fluid from the reactor vessel into the top of the discharge chamber 155′. As shown, the discharge chamber 155′ is disposed at the end of the holding tank 111′ adjacent to the services area end 103′ and returns liquid back to the holding tank.

An important feature of this arrangement of the liquid inlet means is that the level of the liquid within the reactor vessel can virtually be set by adjustment of the flow regulator 191a′ alone, without effecting throughput, the latter being determined by the pump speed and the regulator valve 161′ and control valve 193′. This enables the pressure head within the reactor vessel 153′ to be varied so as to determine the level that liquid reposes within the column, which is preferably just below the junction between the fractionation column 153a′ and the aggregation chamber 153b′, without having to alter the throughput.

The second embodiment is directed towards a tank system for fish as shown in FIGS. 9 through to 14 that is sufficiently large to efficiently handle volumes of fish on a relatively large scale for commercial purposes.

The tank system 10 comprises a large main tank 11 that is divided into a holding tank 15 and a filtering area 17 by an inner partition 13. A pair of longitudinally extending buffer tanks 19a and 19b is provided so that one buffer tank is disposed on either longitudinal side of the main tank 11.

The tank system 10 includes a main services area 101 at one end thereof, which accommodates the main operating components of the tank. These include:

a pair of main pumps 21a and 21b connected by a network of pipes on the inlet side to the respective buffer tanks 19a and 19b and the filtering area 17, and by corresponding pipes on the outlet side to the main tank 11 for recirculating fluid throughout the main tank 11 via the buffer tanks and filtering means;

a supplementary filtering means in the form of a foam fractionator, which functions as a solids extracting means or protein skimmer 25, the inlet side of which is connected via an auxiliary pump 102 to the suction pipe 103 of a prefilter 104;

a discharge chamber 105, which is supplied with fluid outlet from the protein skimmer 25 via an outlet pipe 73, for discharging ozone and other gases entrained into the water by the protein skimmer during the fractionation process;

a fluid cooler means in the form of refrigeration system including a cooler or evaporative coil 75 disposed in the discharge chamber 105, a condenser (not shown) and a compressor (not shown); and

an air compressor 106 which is connected to an outlet pipe 59 disposed along the bottom of the filtering area 17.

The main pumps 21, protein skimmer 25 and fluid cooler means are all disposed at one end of the system 10, adjacent to the end wall 11a of the main tank, in a separate services compartment.

The inner partition 13 maintains separation of the contents of the holding tank 15 and the filtering area 17 and has a tank discharge means surmounted thereon. The tank discharge means comprises a primary lip 29a and a secondary lip 29b, the lips respectively forming the opposing upper edges of a chamber 107 which forms part of the prefilter 104.

The tank discharge means effectively provides a knife edge by virtue of the primary lip 29a over which water may cascade and a sequential flow path to guide fluid to the middle of the filtering area 17, over the secondary lip 29b and a ‘v’ shaped upper drip tray 47.

Filtering means in the form of a biofilter 31 is disposed in the area 17. The biofilter 31 is of known design, consisting of a biomass comprising a multitude of bioballs within which active bacteria may grow.

The bacteria feeds on and thus cleans water and fluid flowing through the biofilter of ammonia and nitrite, which is excreted by the fish or other aquatic animals contained within the holding tank. Thus, the biofilter 31 performs an important filtering and cleansing function for the water 23 contained within the holding tank portion 15 when live fish are disposed therein.

In the present embodiment the continuous flow of water from the holding tank 15 to the filtering area 17 is provided by filling the holding tank with sufficient water 23 to allow it to continuously cascade over the primary lip 29. Thus, the discharge means relies upon discharging water 23 from the holding tank 15 in a continuous flow from the top of the holding tank 15, immediately adjacent to the primary lip 29 of the tank discharge means.

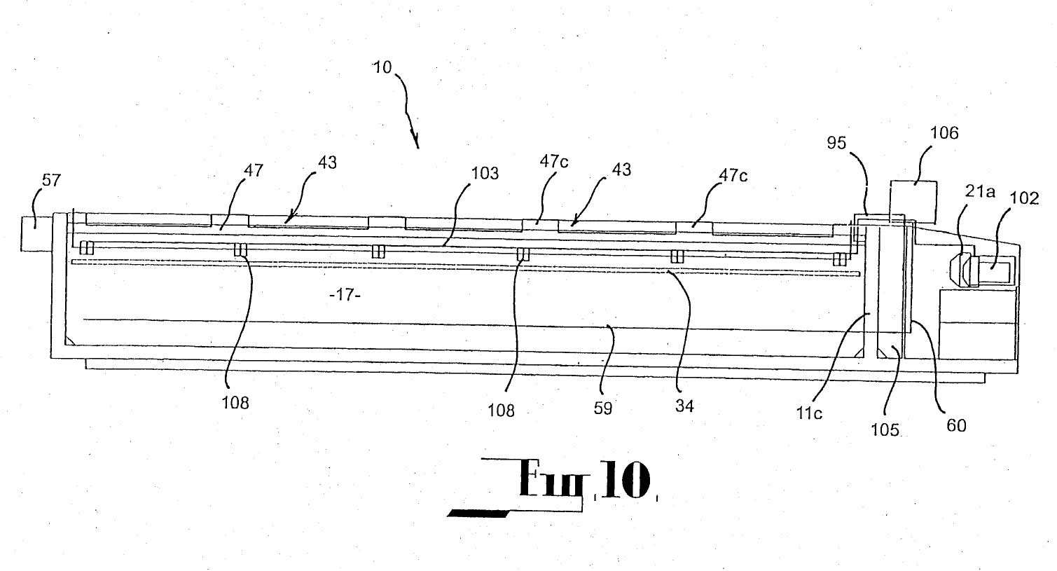

As shown in FIG. 12 of the drawings, the suction pipe 103 is circular in diameter and is positioned generally centrally within the chamber 107 so that the external surface of the pipe extends longitudinally along the chamber in parallel spaced relationship to the walls of the chamber. In this manner, a convoluted passageway is defined for water flowing over the top of the primary lip 29a. The passageway is defined between the anterior wall of the chamber that is contiguous with the primary lip 29a and the anterior of the suction pipe 103, then around the bottom of the pipe 103 through the space between the bottom of the pipe and the bottom of the chamber, and then up through the space defined between the posterior of the pipe 103 and the posterior wall that is contiguous with the secondary lip 29b.

The positioning of the suction pipe 103 relative to the walls and bottom of the chamber 107 forms a flow diverting means that diverts and reverses the flow of water from the cascading flow over the primary lip 29a, so that a reversing and opposing liquid flow is created at the posterior side of the chamber directly adjacent to the cascading flow from the primary lip. This reversing flow subsequently cascades posteriorly with respect to the chamber, over the secondary lip 29b.

Importantly, the reversing and opposing flow of water within the chamber 107 functions to separate and retain solids in the convoluted flow around the pipe 103 in order to allow them to be extracted by a series of inlet holes (not shown) provided in the inlet pipe 103.

The arrangement of the inlet holes is such that the holes are located at spaced apart intervals along the anterior surface of the pipe 103, the holes being relatively closely spaced apart at, for example, 50 millimetre intervals at the end of the pipe farthest from the services end 101 of the tank system, and gradually increasing in spacing to, for example 200 millimetres apart at the proximal end of the pipe 103 to the services end 101. The inlet holes are typically of a diameter of 8 millimetres, however all of these dimensions may vary, depending upon the particular flow rate of the water through the prefilter 104, desired to be achieved and the particular type of aquatic life that is accommodated within the main tank 11.

The prefilter 104 is disposed immediately adjacent to the ‘v-shaped’ upper drip tray 47, which accommodates a replaceable water permeable mat (not shown) therein. The upper drip tray 47 is positioned so that the anterior side of the ‘v’ is contiguous with the posterior side of the secondary lip 29b, whereby the reversing flow of water cascades over the secondary lip and onto the mat. As shown in FIG. 12 of the drawings, the posterior of the secondary lip 29b forms a flap which surmounts the mat and the anterior side 47a of the tray.

The chamber 107 and the tray 47 are supported in position by a plurality of crossbraces 108 which transversely span the top of the filtering area 17. Each cross-brace 108 is fixed at one end to the partition 13 and at the other end to the outer side wall 11a of the main tank 11. The top of each cross-brace 108 is particularly configured so as to define a rectangular recess adjacent to the partition 13 to seat the chamber 107 therein and a ‘v-shape’ recess intermediate the remaining portion of the brace, closer to the side wall 11a to seat the upper tray 47 therein.

The upper drip tray 47 is provided with a plurality of holes along the posterior side 47b of the ‘v’. These holes are provided at various locations along the side 47b to allow for the transfer of water gravitating through the mat, into the filtering area. The tray is also provided with a series of posterior flaps 47c which surmount the top of the outside wall 11a of the main tank 11 at periodical locations along the longitudinal extent of the wall. In this manner, rectangular shaped recesses 48 are defined between the flaps 47c, the recesses having an inner end sufficiently spaced from the inner edge of the wall 11a so as to maintain a gap 43 within the filtering area 17 adjacent to the inner surface of the wall 11a. The gap 43 is provided and maintained by the recesses 48 for venting CO₂ gases and the like from the filtering area, which are the by-products of the active bacteria of the biofilter.

The cross-braces 108, chamber 107 and tray 47 are all made from plastic. The cross-braces are spaced apart sufficiently to support the weight of the chamber 107 and tray 47 when they are filled with water.

The area beneath the chamber 107 and the drip tray 47 is filled with bioballs 32 to a height below the cross-braces 108, which are covered by a planar perforated lower drip tray 34. The lower tray 34 is covered with a plastic membrane and is divided into separate trays which span the entire longitudinal extent of the filtering area 17. The lower trays 34 have a transverse extent in order to enable them to abut against the inner side wall of the partition 13 along one side, but remain spaced from the inner surface of the outside wall 11a at their other side, so as to maintain the gap 43 between the tray and the wall 11a.

The bottom of the filtering area 17 has two pipes sequentially disposed in axial alignment, intermediately spaced between the outside wall 11a and the partition 13. The pipe closer to the services area end 101 of the tank system serves as a water suction line 61 for draining the filtering area of liquid from the bottom of the area 17. The other pipe serves as a water balancing line 62 between the filtering area 17 and the buffer tanks 19 and will be described in more detail later. Both lines 61 and 62 form part of the network of pipes which is ultimately connected to the main pumps 21a and 21b via the buffer tanks 19, in a manner that will be described in more detail later.

The air outlet pipe 59 is also disposed towards the bottom half of the filtering area 17, but at an elevated position with respect to the water suction line 61 and at a position proximate to the outer wall 11a9 . The air outlet pipe 59 extends substantially the entire longitudinal extent of the filtering area 17a in spaced parallel relationship to the water suction line 61 and water balancing line 62, and is provided with a series of outlet nozzles (not shown) through which air, or preferably oxygen, supplied under pressure from the compressor 106 is injected into the filtering area. Accordingly, the compressor 106 is connected to the end of the outlet pipe 59 proximal to the services area 101 by means of an air pipe 60 disposed in the services area 101.

Operation of the biomass is enhanced by the supply of air or oxygen thereto. Accordingly, the air outlet nozzles are disposed rectilinearly along the air outlet pipe 59 at an oblique angle relative to the vertical and horizontal, so as to inject air or oxygen into the biofilter 31 transversely across the filtering area 17 towards the partition 13. The direction of the nozzles has an upward component so as to reflect off the wall of the partition and be vented ultimately through the gap 43 provided adjacent the inner surface of the outside wall 11a. Consequently, air or oxygen is able to rise up through the water within the biofilter and permeate the biomass, air stripping ammonia from the water therein.

In the present embodiment a secondary outlet/inlet pipe 59a is also provided in the filtering area 17 and is connected to a corresponding pipe 60a at its proximal end to the services area. This pipe 60a can be optionally connected to the compressor 106 and act as a second air outlet pipe for cleaning purposes. In normal operation, however, it is disconnected from the compressor. Alternatively, the outletting pipe 59a can be connected differently to recirculate fluid through the biofilter 31 and keep the bacteria alive, in a shutdown or transport mode of the main tank system.

Moreover, in this shut down or transport mode, the outlet/inlet pipe 59a acts as a fluid inlet pipe to drain liquid from the bottom of the biofilter 31. In this arrangement, the pipe 60a is connected to the inlet of the auxiliary pump 102 and the outlet of the auxiliary pump is disconnected from the protein skimmer 25 and in turn is connected to the suction pipe 103 in the chamber 107, reversing the function of the suction pipe 103 to constitute a fluid outlet pipe. Consequently, operation of the auxiliary pump 102 draws fluid from the bottom of the biofilter and feeds it into the chamber 107 to subsequently spill over the secondary lip 29b and into the upper drip tray 47 to subsequently gravitate through the biofilter.

In this condition, the remainder of the tank system is shut down, without water being circulated through the holding tank 15 into the biofilter.

In an alternative arrangement still, in the shut down or transport mode, the main pump 21a can simply be cut down to an operational speed of 25% of its main speed, which is sufficient to cause a minimal recirculation of fluid through the biofilter in order to keep the biomass alive. Reduction of the speed of the main pump down to 25% of its optimum speed causes a massive reduction in power usage of the tank system making it an extremely viable arrangement in which to run the system in a shut down or resting mode.

The water suction line 61 is connected to what essentially constitutes at its proximal end a manifold 109 in the services area 101. The manifold 109 includes a pair of branches 109b and 109a, which are respectively connected to the inlet lines 110a and 110b of the motors 21a and 21b respectively. As is shown in FIG. 9, the branch 109a and the inlet pipe 110a effectively constitute the same pipe.

The manifold 109 is also fed by respective outlet pipes 80a and 80b connected to the buffer tanks 19a and 19b respectively. The buffer tank outlet pipes 80 are each connected to the manifold 109 by way of stop valves 81aand 81b respectively. The stop valves 81 operate in the event of a power failure to close the outlet pipes 80aand 80band maintain the level in the buffer tanks 19a and 19b and thus the level of water in the biofilter 31.

In order to achieve this effect, the buffer tanks 19 are interconnected by a balancing manifold 82 at the opposite end of the main tank 11 relative to the services area 101. This balancing manifold has two arms, one arm 82a connected to the distal end of the buffer tank 19a and the other arm 82b connected to the distal end of the buffer tank 19b. A common branch 82c of the manifold is connected to the water balancing line 62, which functions to provide a common supply of fluid to the buffer tanks 19 from the bottom of the filtering area and balancing of the water levels between the buffer tanks and the biofilter 31.

In normal operation, water within the filtering area 17 is kept at a threshold level so that it may not backflow through-the biofilter 31 and over the lips 29 into the holding tank 15 by means of the buffer tanks 19a and 19b, as an adjunct to the recirculating means. This is achieved by the buffer tanks 19a and 19b each being connected to the bottom of the filtering area 17 by the respective passageways described above. Thus, water can flow in either direction along these passageways in order to ensure that the water level within the area 17 does not exceed a prescribed threshold level, notwithstanding surges in the volume of water flow through the biofilter 31, which will occur when introducing product into the holding tank. This prescribed threshold level is controlled by the buffer tanks being disposed in substantial horizontal alignment with the filtering area 17, as shown in the drawings, and the buffer tanks being provided with sufficient headroom to maintain the prescribed threshold level below the top of the biofilter 31. Thus, the water level within the buffer tanks will rise and fall, depending upon the volume of water flowing through the biofilter, to ensure that the water level within the area 17 essentially does not rise above the height of the buffer tanks.

In practice, as additional product is loaded into the holding tank 15, excess water flows over the lip 29 into the biofilter 31. The excess water flows into the buffer tanks via the interconnecting passageways to avoid backflow of water through the biofilter 31. When the product is removed from the holding tank, the main pump 21 continues to draw from the water in the bottom of the filtering area 17, and thus the buffer tanks 19 allow water to flow back into the filtering area and thus back into the holding tank to replace the water which was displaced by the product. Once the holding tank is filled with sufficient water, the water will cascade over the lips 29 again to maintain the cross-flow of water within the holding tank, and continuous down flow of water through the biofilter.

The buffer tanks 19 are each partitioned into three discrete compartments 83. The compartments are arranged sequentially from the distal end of the tank system to the proximal end of the tank system, relative to the services area end 101. Consequently, there is a distal compartment 83a, an intermediate compartment 83b and a proximal compartment 83c in each buffer tank. The partitioning of the buffer tanks into compartments graduates the flow of water from the manifold 82, through the respective distal compartments 83, and eventually into the proximal compartments 83c. It is then outlet via the outlet pipes 80a and 80b and inlet to the manifold 109 for pumping by the main pumps 21a and 21b. Additional filtering and pH levelling can be undertaken conveniently in the compartments of the buffer tanks. Moreover, appropriate filtering means, such as coral, sponge and limestone rocks are disposed in one or more compartments. In the present embodiment, the intermediate compartment 83 of the buffer tank 19b is used for this purpose.

Additionally, the buffer tanks can be used to gauge the level of water in the biofilter 31 and allow for water to be supplied to the system in order to maintain and/or increase the level of water in the biofilter at periodical times.

In the present embodiment, the. proximal compartment 80c of the buffer tank 19b is provided with a water level marker and float level control (not shown). The water level marker is used to gauge the level of water in the biofilter 31 and the float level control is connected to the controller to introduce water into the system and/or inform an operator of water loss which may require resetting of the tank's parameters.

Each of the compartments 83 are provided with a lid to enable access to the contents thereof, which lid can provide an elevated platform in the closed position for walking along and accessing the contents of the holding tank 15, when required.

The network of pipes connected to the main pumps 21 is completed to provide the recirculating means of the tank system. In this regard, respective outlet pipes 65a and 65b of the pumps 21 are connected via stop valves 85a and 85b respectively to a pair of water inlet lines 67a and 67b which are situated in the holding tank 15.

The water inlet lines 67a and 67b form the water inlet means of the tank system and comprise pipes extending longitudinally of the holding tank from the proximal end to the distal end thereof. The water inlet line 67a is disposed at the bottom of the holding tank proximate to the partition 13, whereas the water inlet line 67b is oppositely disposed at the bottom of the tank proximate to the outside wall 11b of the tank.

Both of the inlet lines 67 are provided with a series of inletting nozzles comprising holes formed rectilinearly in the pipes so as to inlet water under pressure into the holding tank and create a uniform, circulating flow of water therein about a substantial horizontal axis. Accordingly, the nozzles of the water inlet line 67b are disposed to inject water at an oblique angle relative to the horizontal and vertical, in a substantially upward direction and transversely across the holding tank towards the partition 13. The nozzles in the inlet line 67a are similarly disposed but direct water at an oblique angle having more of a horizontal component and towards the outside wall 11b. In this manner, both pumps can be operated to create a rapid cross-flow of water within the holding tank to optimise the aquatic environment for aquatic animals within the tank.

The position of the water inlet lines 67 relative to the discharge means is particularly important in that it allows for an optimum circulation of water flow within the holding tank 15 itself. Moreover, the water inlet lines are disposed opposite to and extend generally parallel with the tank discharge means and have their inletting nozzles directed so that water tends to move in a circular cross flow manner about a substantially horizontal axis. Thus water, when jetted from the water inlet lines 67, tends to flow up along the inner face of the outer wall 15a towards the surface of the water 23, then from the inner wall 15a to the partition 13 along the top of the holding tank so that part of the water cascades over the primary lip 29a and part of the water continues to circulate down along the inner wall 13b of the partition 13 towards the bottom of the holding tank, and then across the bottom of the tank 15b to the inner wall 15a. This circulatory motion tends to avoid the creation of dead spots and allows a uniform cross flow of treated water throughout the holding tank, equally sustaining aquatic animals disposed at any location within the tank.

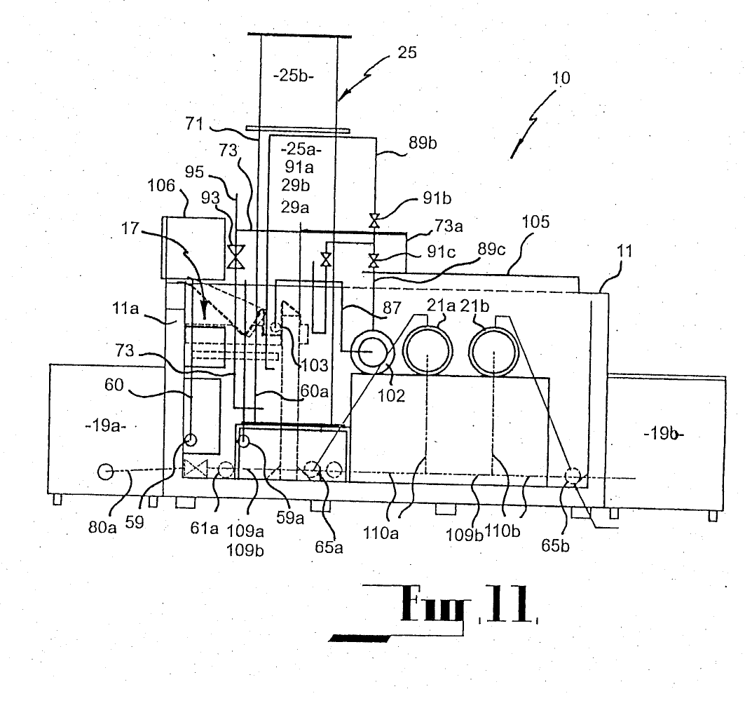

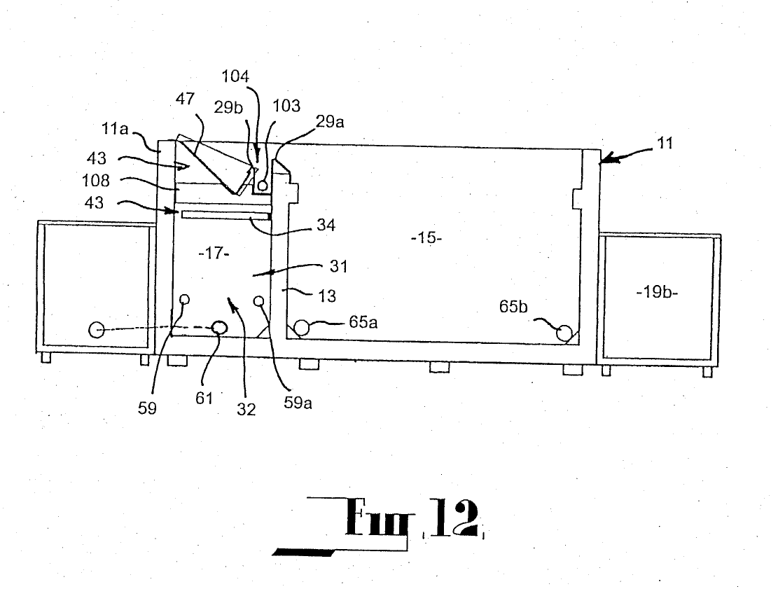

A particular aspect of the present embodiment which is best illustrated in FIGS. 13 and 14, is that the water inlet lines 67a and 67b respectively have rectilinear arrangements of inletting nozzles for jetting fluid into the holding tank, which extend longitudinally thereof. This rectilinear arrangement of inletting nozzles is disposed so as to be marginally offset from a true parallel relationship with the horizontal axis. This is most readily achieved by elevating both of the inlet lines within the holding tank at one end. In the present embodiment, as shown in FIG. 14 of the drawings, this is at the services end 101 of the main tank. In an alternative embodiment, the same effect may be achieved by disposing the inletting nozzles in a marginally helical configuration so that the nozzle at one end is directed at a more acute angular position relative to the bottom of the holding tank than the nozzle at the opposing end.

The former, however, is the preferred arrangement as better cross-flow is achieved.

This marginal offset from the horizontal generates a latent axial flow of fluid relative to the horizontal axis within the holding tank, directing the cross-flow spirally or helically about the central longitudinal axis of the holding tank.

Furthermore, in the present embodiment, the opposing end walls of the holding tank provide a surface to reflect the latent axial flow of fluid along the holding tank, thereby generating an axial back flow of fluid which interferes with the principal latent axial flow. This interference establishes a very subtle wave motion within the holding tank which manifests itself in generating transverse and vertically directed eddy currents at axially spaced apart locations along the surface of the holding tank. These eddy currents tend to focus cross-flow of fluid carrying suspended solids to the top of the holding tank and with the cross-flow of fluid to towards the tank discharge means directs suspended solids over the primary lip 29a, between successive locations of eddy currents. Suspended solids falling into an eddy current, conversely tend to be recirculated within the return cross-flow within the tank, being drawn away from the primary lip. These suspended solids are recirculated and are provided with another opportunity to flow across the surface between successive eddy currents to be focused towards the primary lip and extraction via either the prefilter or biofilter.

It should be noted that protein is always brought to the surface and tends to flow across the primary lip on a continuous basis regardless of the presence of eddy currents.

In normal operation, only the pump 21a is operated on a continuous basis and the pump 21b is operated on a periodical basis to increase water flow through the biofilter 31 to suit the conditions of the environment to be achieved. Accordingly, the particular duty cycle of the pump 21b can be altered to suit the particular species of animal accommodated within the tank and to stabilise the environment to suit the reconditioning of aquatic animals when first placed in the holding tank.

In order to drain water from the buffer tanks 19 and the filtering area, a water outlet pipe 49 is connected to the pump inlet pipe 110a via a stop valve 50 to divert water flow that normally flows to the pump 21a. In order to fill the holding tanks 15 with water, if required, a water inlet pipe 51 is connected to the outlet of the pump 21a and into the water inlet line 67a, via a stop valve 52. A separate water outlet drain (not shown) is provided in the end wall opposite the services area 101 in the holding tank, to drain water therefrom, when required. Accordingly, ingress and egress of water to and from the tank system is controlled by operation of the valves 50 and 52, which can be attended to either manually, or automatically via a controller (not shown) located within a controller housing 57. The controller will be described in more detail later.

The water inlet pipe 51 can be supplied by a mains pressure hose (not shown) and a standard solids/activated carbon filtration system (also not shown). The stop valve 52 would then be in the form of a solenoid valve controlled by the controller. The controller could then automatically close the system with fresh water in response to any detected increase in salinity arising from evaporation of fresh water. In this manner the amount of water within the system can be maintained at a predetermined level corresponding to a prescribed salinity.

The protein skimmer 25 is connected into a discrete protein circuit to supplement the filtering function of the biofilter 31. Moreover, the protein skimmer 25 functions to remove suspended solid materials from the holding tank such as shellfish excrement, detached limbs or the like, as well as protein, and performs a supplementary filtering and cleansing action to the biofilter. It operates by sucking water and solids from the prefilter via the suction line 103 and the auxiliary pump 102, passing the same through the main fractionation column 25a of the protein skimmer 25 where the water is injected with ozone and/or oxygen to entrain the solids within the resultant foam, and is then fractioned off before the filtered water is returned to the holding tank via suitable return means. The foam containing entrained protein and solids is expelled into a foam collecting chamber 25b, surmounting the fractionation column 25a, via an interconnecting passageway (not shown). Collected foam is outlet via foam outlet means (not shown) from the chamber, periodically.

The injection of ozone and/or oxygen through the water not only promotes the foam fractionation process but also treats any ammonia and nitrites in the water caused by the excretia of the aquatic animals converting it into a relatively inert nitrate form, which is harmless in the aquaria environment.

In the present embodiment, the suction pipe 103 is connected to the inlet of the auxiliary pump 102 via an inlet pipe 87. The outlet of the pump 102 is then connected via a branching circuit including a coupling to an upper inlet pipe 89a and a lower inlet pipe 89b, which are in turn connected to different levels of the fractionation column 25a to complete the inlet side of the protein circuit. Flow control valves 91 are connected to each of the branches of the branching coupling so that control valve 91a is provided along the inlet branch 89a, control valve 91b is provided along the inlet branch 89b and the control valve 91c is provided along the main outlet 89c of the auxiliary pump 102.

Aerating means in the form of a Venturi (not shown) is incorporated into the lower inlet branch 89b for introducing ozone into the fractionation column 25a.

The outlet side of the protein circuit comprises an outlet pipe 73 which connects the outlet of the fractionation column 25a, proximate the bottom thereof, to the discharge chamber 105. The outlet pipe 73 is also provided with a control valve 93 and a vent 95 to control the outlet flow of fluid therefrom and to vent gases such as ozone and oxygen introduced into the water during the foam fractionation process, on its way to the discharge chamber 105. The distal end 73a of the outlet pipe discharges fluid from the foam fractionator into the top of the discharge chamber 105.

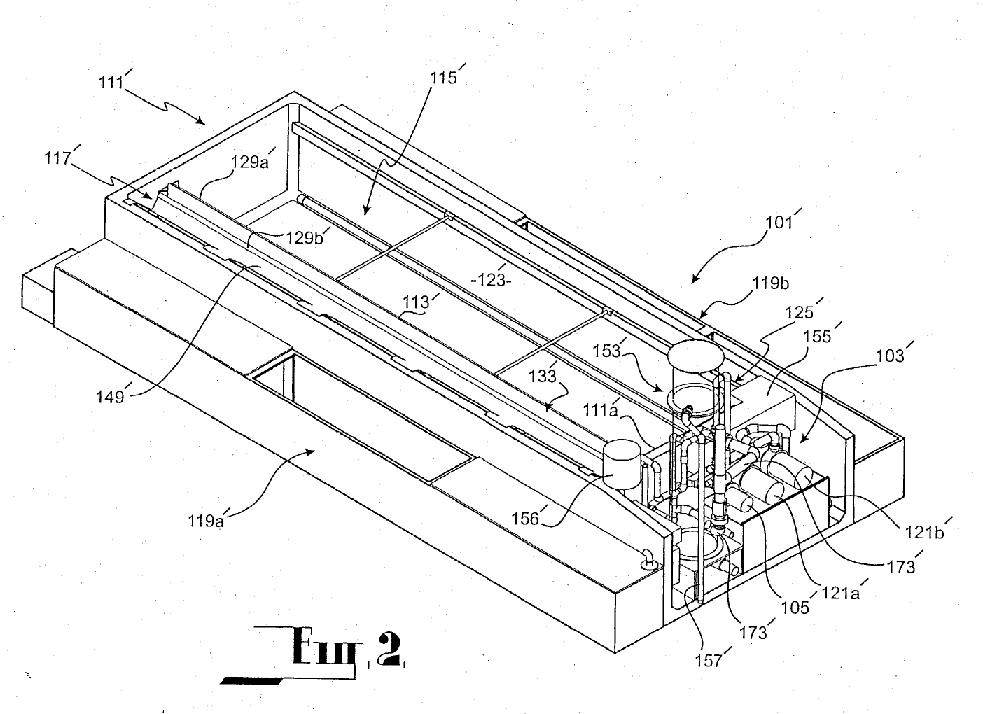

The discharge chamber 105 is disposed at the end of the holding tank 11 adjacent to the services area end 101. As shown in FIGS. 2 and 4, the distal end 73a of the outlet pipe 73 discharges filtered fluid from the protein skimmer 25 into the discharge chamber 105, at the end of the chamber proximate to the filtering area 17. The opposing end of the discharge chamber 105 is formed with an upper discharge port 95 which overlies the end wall 11c of the holding tank adjacent to the services area 101. Thus, the top 105a of the discharge chamber is disposed at a level above the top of the partition 11c to accommodate an opening in the discharge port 95, through which water within the discharge chamber can cascade over the partition 11c and into the holding tank 15. The opposed location of the discharge port 95 and the distal end 73a of the outlet pipe 73 allows a further opportunity for degassing of gases and ozone entrained within the fluid outlet from the foam fractionation process.

The discharge chamber 105 also provides a convenient location to situate the evaporative coil 75 of the refrigeration system. Accordingly, the condenser and compressor (not shown) of the refrigeration system can be operated via a thermostat control (not shown), forming part of the controller, to adjust the temperature of water entering the holding tank via the discharge chamber. Thus, temperature control of the water within the holding tank can be maintained and reduced, if necessary, by controlled operation of the refrigeration system.

The entire system can be monitored and controlled by the controller within the controller housing 57. The controller includes a microcomputer system which is connected to suitable probes for measuring ORP (measurement of water quality), pH, salinity and temperature of the water within the system. An appropriate chemical dispenser (not shown) is provided to maintain optimum pH and salinity levels in accordance with a prescribed control program which is run by the controller. As previously described, the temperature of the water can be controlled by the controller using the refrigeration system previously described.

The controller housing 57 also includes a modem and telecommunication link (not shown) which allows for remote connection, monitoring and control of the tank system.

Although not shown in the drawings, the bottom 15b of the holding tank can have disposed therein a basket stand made from PVC or other appropriate material. The basket stand provides an elevated platform on which a plurality of baskets containing the aquatic animals, such as shellfish, may be disposed in a confined environment within the holding tank. The baskets may be stacked on and arranged in rows to substantially occupy the entire content of the holding tank 15.

The basket stand provides clearance between the bottom baskets and the bottom 15b of the holding tank to facilitate water circulation along the bottom of the holding tank.

The tank system 10 is of modular form, whereby the two buffer side tanks 19a and 19b are connected to the main tank by quick release couplings. This allows the buffer tanks to be removed and stacked on top of the main tank 11 for transport purposes. The pumps, biofilter 31 and all controllers are built onto the main tank 11. Thus, in order to install the tank system, it is simply a matter of locating the main tank and its components on the ground, connecting the buffer tanks to the main tank, filling the main tank with water, and connecting up an appropriate power supply to the various components.

In this manner, the system is quite portable, where it can be transported to virtually anywhere throughout the world.

An important feature of the system 10 is that the flow of water 23 from the holding tank 15 to the biofilter area 17 is effected by gravitation, whereby pumping is only necessary to transfer water from the bottom of the filtering area 17 to the water outlet line 67 in a substantially horizontal plane. Thus, it is not necessary to utilise a large capacity pump as has previously been necessary for transferring water in prior art tank systems.

The particular arrangement of the buffer tanks 19 also enables the buffer tanks to form a platform along which an operator may walk alongside the holding tank and tend to product therein. In addition, the modular nature of the system allows for it to be connected up in parallel whereby a plurality of tank systems may be disposed alongside each other to increase the product capacity.

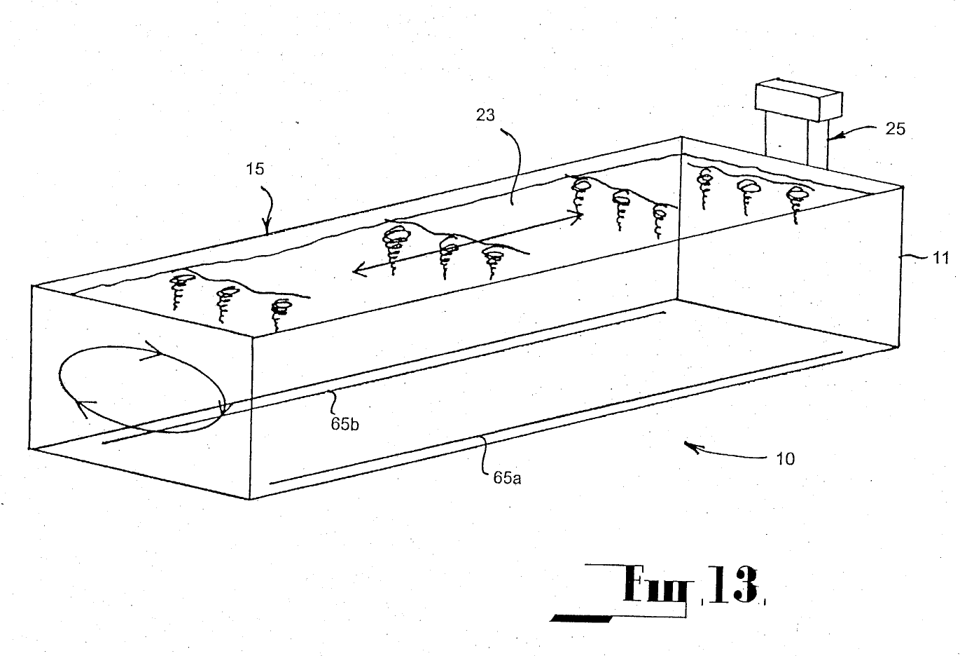

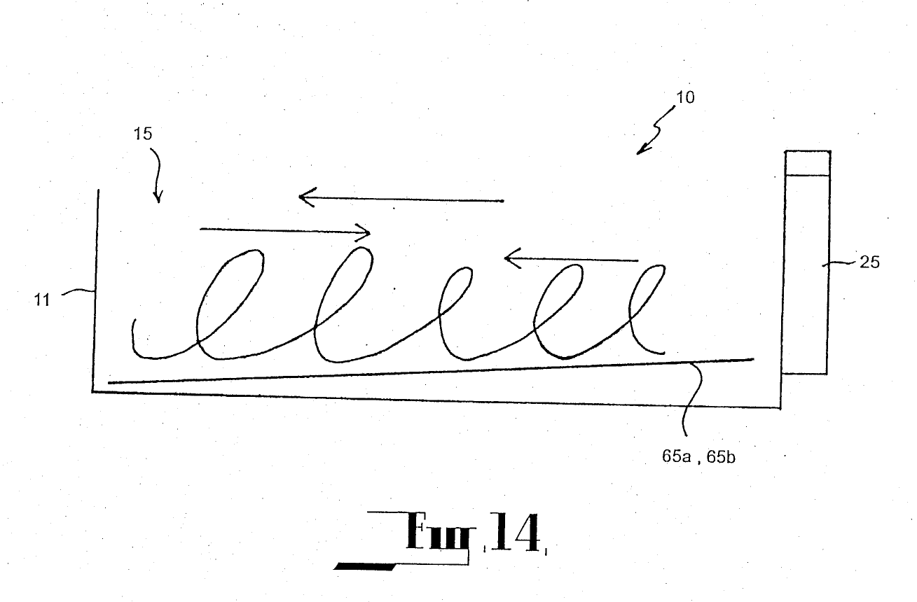

As shown in FIGS. 15 and 16, three discrete tank systems are shown disposed alongside each other whereby adjacent buffer tanks 19a and 19b of adjacent systems combine to form a single platform 81 along which an operator may walk to access the contents of the holding tank 15 or the biofilter 31.

The third embodiment is substantially similar to the second embodiment in principle, but differs from the tank system of the second embodiment, principally in terms of scale, being much smaller, and intended for display and research purposes.

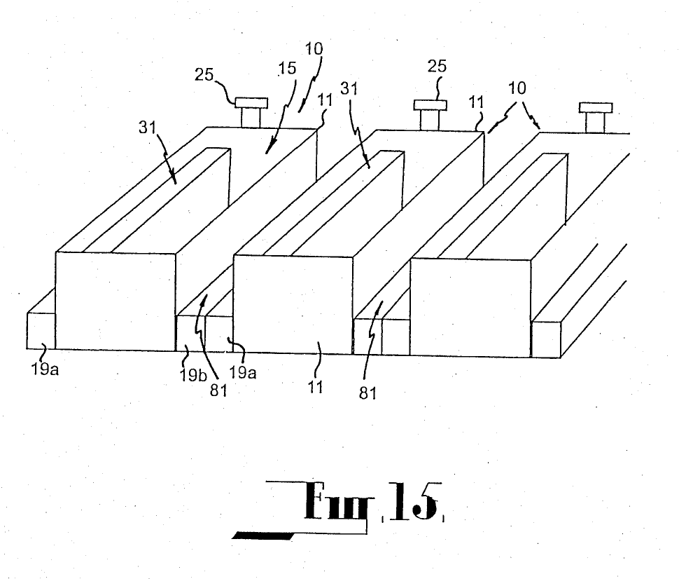

As shown in FIGS. 17 to 23, the tank system 121 comprises a main tank enclosure 123 which houses essentially all of the components of the tank system, including the holding tank 125, the filtering area 127 and biofilter 129, a single buffer tank 131 and a machinery space 133 for containing the various operating components of the tank system.

As can be seen in the plan views, the basic arrangement of the tank system is divided into three transversely extending sections, the first being the holding tank 125, the second being the filtering area 127 and the third being the buffer tank 131 and the machinery space 133.

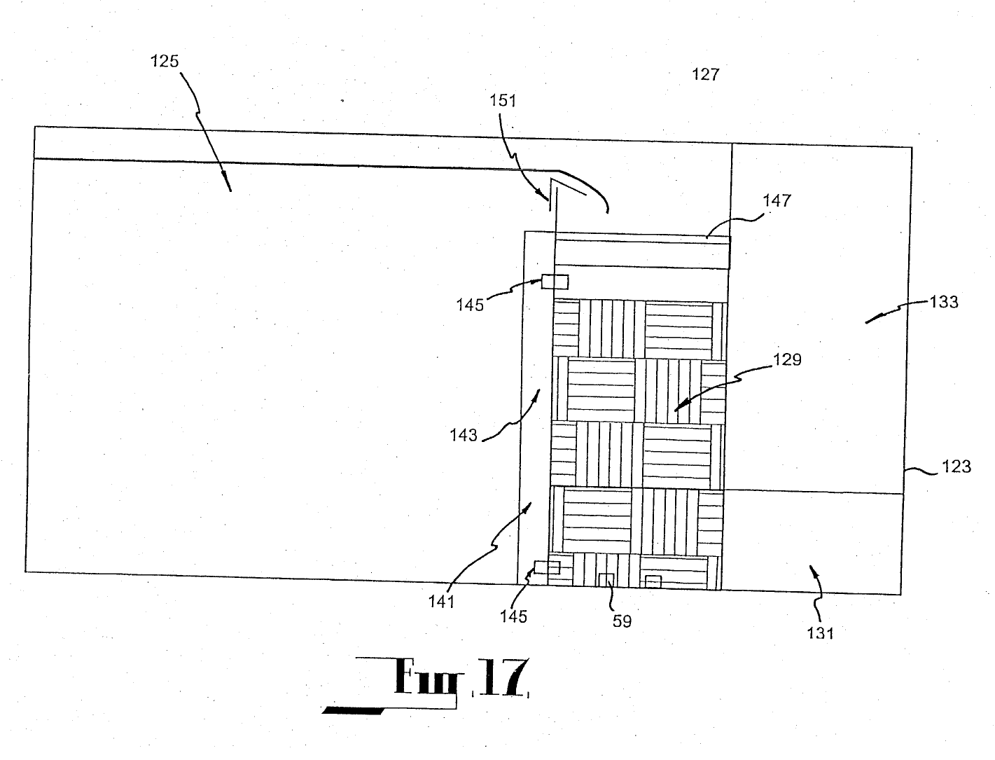

As shown in FIG. 19 of the drawings the top of the tank system is covered by three lids, two lids 135a and 135b being disposed over the holding tank 125 and the filtering area 127, and a third lid 135c being disposed over the buffertank 131. That portion of the lids 135a and 135b covering the filtering area 127 has holes 137 formed therein to allow for venting of CO₂ and nitrate from the biofilter 129.

In the present embodiment, the biofilter 129 has bioballs housed within discrete elements 33 of the type shown in FIG. 14, which may be clipped in to position within the filtering area 127. Thus a plurality of these elements 33 can be positioned in this way to occupy substantially the entire area 127.

The biofilter elements 33 are formed with an external plastic casing 35 which is permeated with holes 37 at appropriate locations in order to allow water to enter and gravitate down through the element. The bioballs 37 are housed within the casing between two layers 39a and 39b of permeable material, respectively disposed at the top and the bottom of the casing.

A clip 41 is provided along the rear side of the element 33 adjacent to the top to facilitate clipping the element to a series of hooks (not shown) which are formed along the confronting face of the partition 131, bounding the area 127 of the filtering means. Accordingly, the elements 33 can be clipped into position to occupy essentially all of the volume of the area 127 and to allow discrete removal of elements for maintenance purposes when necessary. A small gap is provided between adjacent elements to allow for the venting of carbon dioxide (CO₂) which is a main by-product of the active bacteria of the biofilter.

The lid 135c also has a series of holes 139 provided therein, but not as closely spaced as the holes 137, to allow for breathing of the buffer tank 131.

The partition 141 is arranged so as to be provided with a refrigeration void 143 within which the condenser coil (not shown) may be disposed. Accordingly, appropriate refrigeration sockets 145 are provided to allow for communication with the water passing through the biofilter 129 to cool the same.

The drip tray 147 is mounted upon a series of drip tray supports 149. The lip 151 in the present embodiment is affixed to the top of the partition 141 so as to form a V-shape knife edge over which water may cascade into the drip tray 147 and down through the biofilter 129 as required.

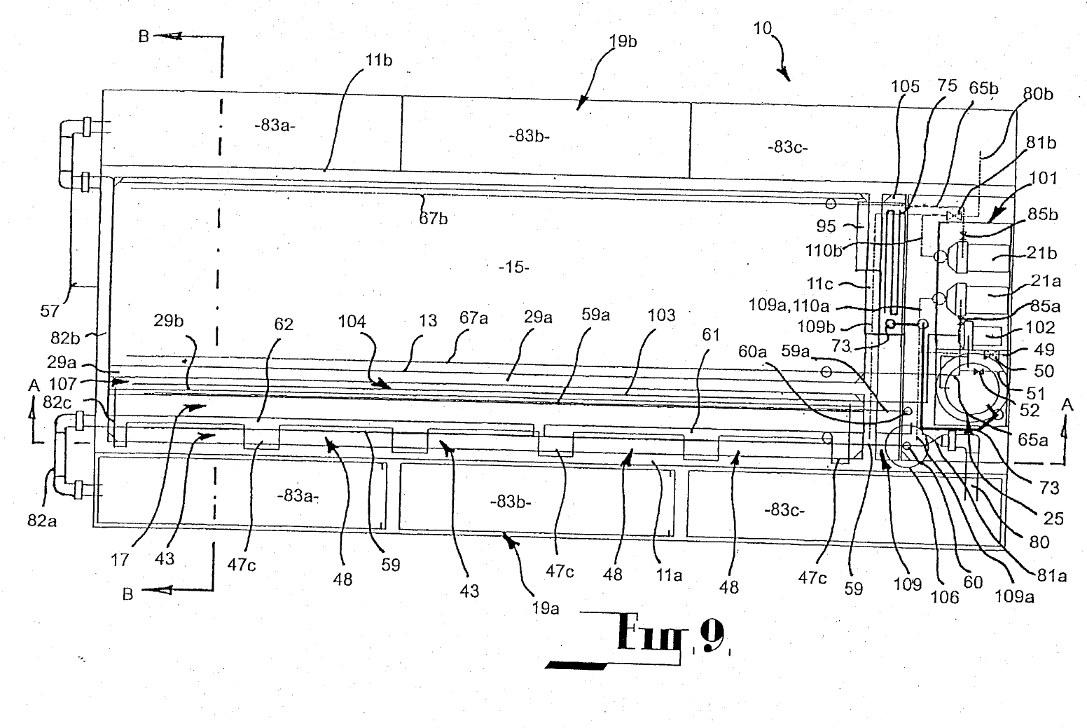

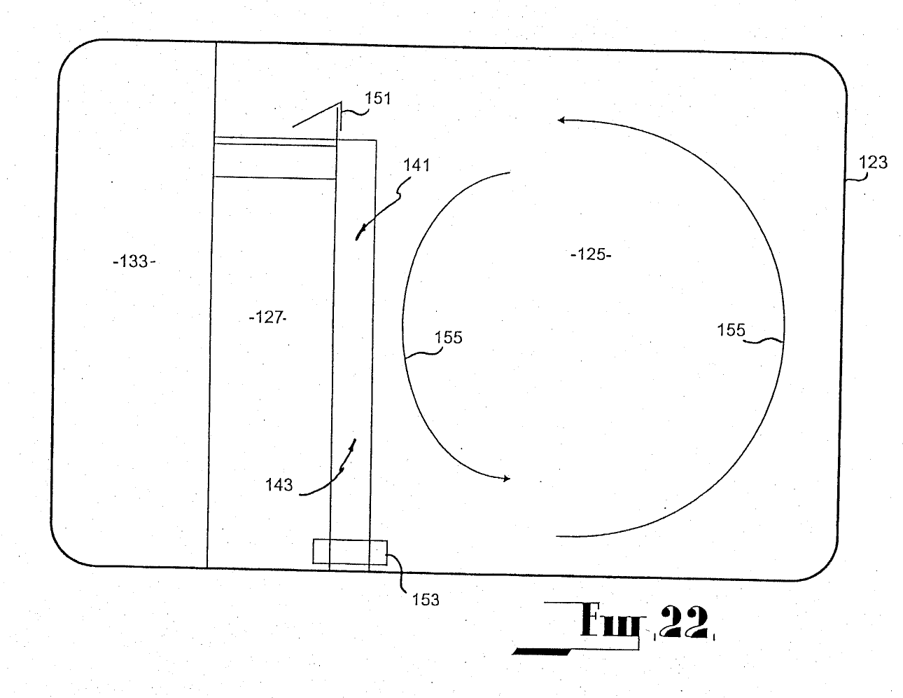

The remaining features of the tank system 121 are essentially the same as those provided in the second embodiment and accordingly corresponding reference numerals are used in the drawings to identify like features. These features are described more particularly in a slight variation to the third embodiment as shown in FIG. 24 of the drawings. In this arrangement, the tank is proportioned differently so that instead of the biofilter, buffer tank and machinery space being located at one end of the holding tank, as shown in FIGS. 11 and 12, these are located along one side of the holding tank, as shown in FIG. 24.

As compared with the preceding embodiment, the arrangement of the recirculating means is marginally different, whereby a water transfer socket 153 is provided at the bottom of the partition 141 to interconnect the water inlet pipe 154 within the holding tank 125 and the main pump 152. The socket 153 is sealed from the contents of the refrigeration void 143.

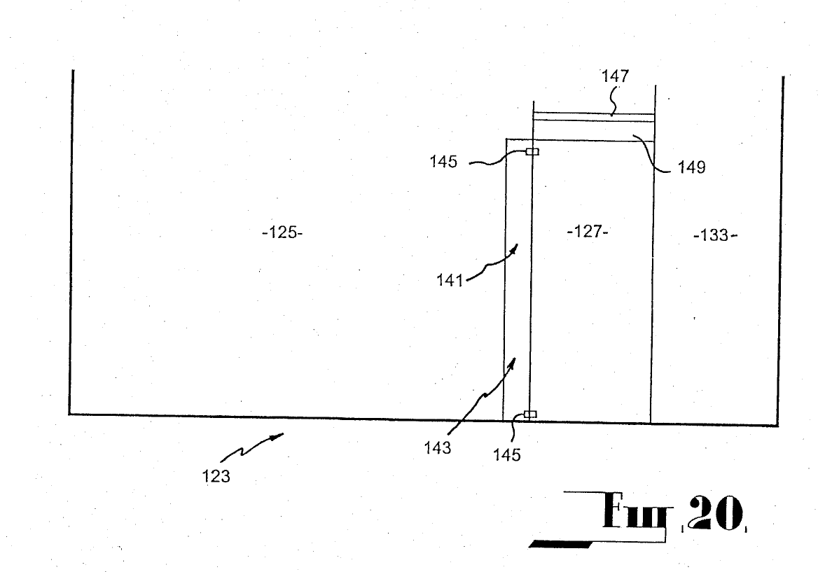

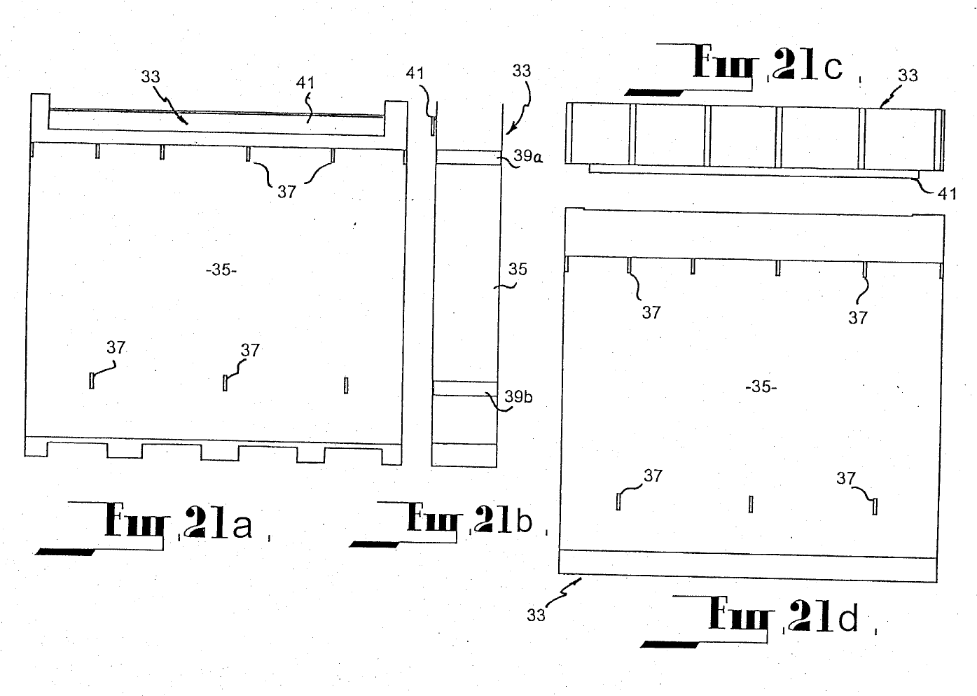

The water inlet pipe 154 is connected to the socket 153 and projects in an L-shape manner to provide a longitudinally extending nozzle pipe 156 at a diagonally opposed location to the lip 151. In order to achieve a uniform cross flow of water within the holding tank 125, as represented by the arrows 155, in the arrangement shown in FIGS. 22 and 23. The main suction pump 152 is a submersible pump and has an inlet suction pipe 158 connected thereto which extends longitudinally along the bottom of the filtering area 127 beneath the biofilter 129.

The protein skimmer 157 and associated protein circuit comprising protein pump 159, water inlet pipe 161 and water outlet pipe 163 are also connected into the tank system as shown in FIG. 19. In this embodiment, the protein skimmer 157 and protein pump 159 are disposed adjacent to the end of the holding tank 125.

The fourth embodiment is another variation of each of the preceding embodiments, but essentially works on the same principle as the tank system described in the third embodiments.

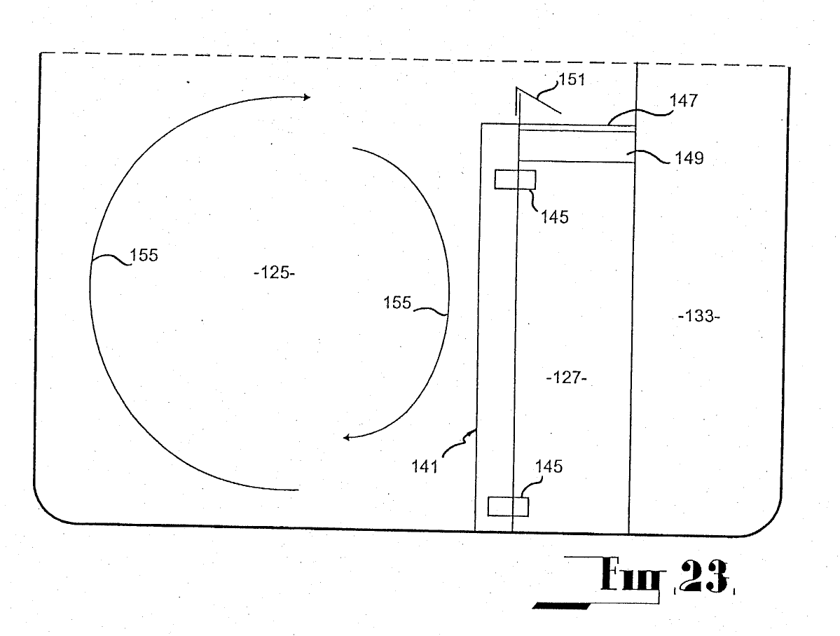

The tank system 171 of the fourth embodiment, as shown in FIGS. 25 to 28, essentially comprises a main tank 173 which is divided into two longitudinally extending holding tanks 175, disposed at either side of a central filtering area 177.

The main tank 173 is actually disposed upon a lower cabinet 179 within which a large buffer tank 181 is disposed together with the remaining operating components of the tank system.

The filtering area 177 includes a large longitudinal biofilter 183 which projects down past the holding tanks 175 to repose in the large buffer tank 181.

The recirculating means includes a main pump 189 having connected thereto a pump inlet 191 which in turn is connected to the large buffer tank 181. The outlet of the main pump 189 has a main pump outlet pipe 192 divided into two separate water supply lines 193a and 193b, which are in turn connected to corresponding water inlet lines 194 for inletting water into the holding tank 175.

With having dual holding tanks 175, essentially a pair of partitions 185 are provided to separate each holding tank 175 from the filtering area 177, and a pair of lips 187 are mounted at the top of the partitions to provide the corresponding knife edges for the discharge of water from either holding tank to the biofilter 183.

Having dual holding tanks not only increases the capacity of the tank system but allows for separate viewing of the holding tanks from either side of the main tank 173. Accordingly, the present embodiment provides for a tank system which has particular utility for display purposes in a shopping centre, for example, to optimise the aesthetic presentation of aquatic animals to potential customers. Thus, in the present embodiment, the cabinet 179 is provided with castors 195 to improve the portability of the tank system, allowing it to be wheeled around to a desired location for display purposes. In addition, it is provided with buffers 197 so as to avoid damage to the cabinet from shoppers.

The fifth embodiment of the invention is generally similar to the second embodiment, adopting the same principle of operation, however it is directed towards a plurality of holding tank modules disposed in a sequential and longitudinally contiguous relationship with each other.

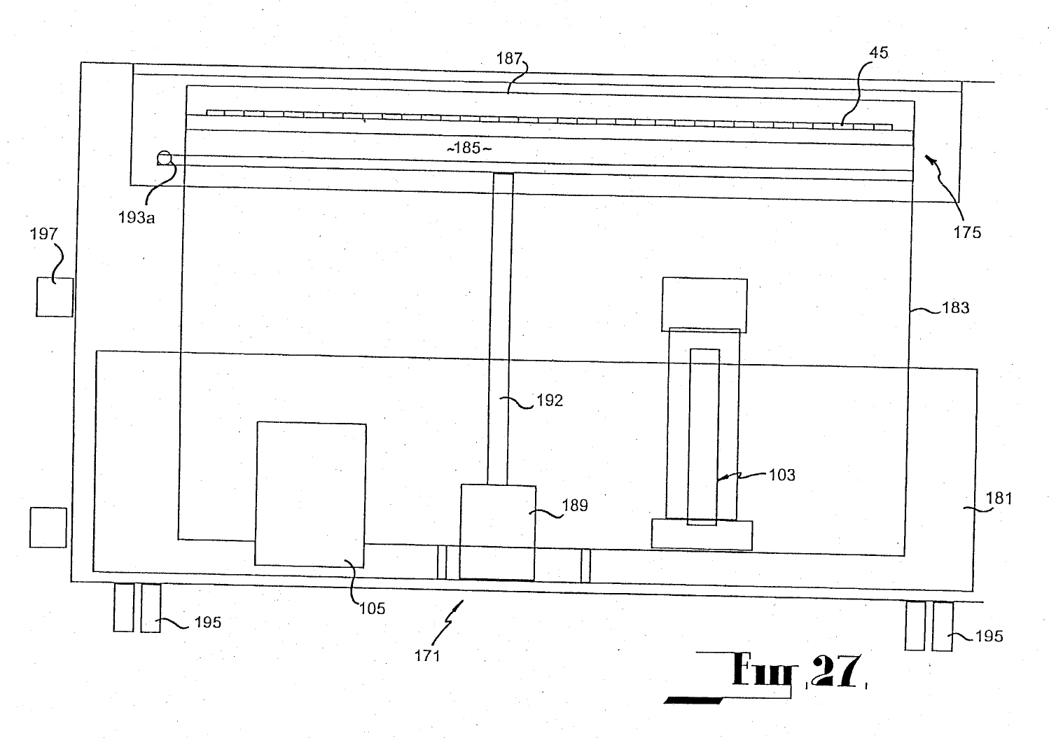

As shown in FIGS. 29 to 31, the tank system 201 comprises a plurality of holding tank modules 203a, 203b . . . 203f.

Each holding tank module 203 is substantially similar to a tank system of the first embodiment except that one or more of its end walls are omitted so as to define a continuous passage 205 extending along the holding tank modules. Accordingly, the end modules 203a and 203f each have one end wall omitted therefrom and are interconnected with adjacent holding tank modules 203b and 203e respectively, both of which have both end walls omitted therefrom.

In this manner, fluid in one holding tank module can flow without restriction to an adjacent holding tank module and vice versa.

In order to accommodate this rectilinear arrangement of holding tanks, the services compartment 207, which in the first embodiment was located at the services end of a holding tank, is now disposed adjacent the side of a buffer tank 209 of each holding tank module. In the present embodiment, this buffer tank 209 is the one located adjacent the filtering area 211.

In order to provide for the creation of eddy currents as a result of aggregation of fluid within the holding tanks, the tank inlet means (not shown) within adjacent tank modules is alternately arranged so that the latent axial flow of fluid in one holding tank module is opposingly directed relative to the latent axial flow of fluid in an adjacent holding tank module. In this manner, latent axial flows oppose each other as arises when reflecting off a wall, similarly generating transversely and vertically directed eddy currents at actually spaced apart locations along the fluid surface of each holding tank module. Consequently, the resultant cross-flow of fluid focuses suspended solids carried thereby to the top of respective holding tanks, adjacent to the filtering area between successive eddy currents to facilitate flow across the tank discharge means and into the prefilter.

The rectilinear arrangement of holding tanks is particularly useful with certain species of fish that are required to accelerate quickly as part of their normal swimming habit, as opposed to reposing in a transverse position within the cross-flow. This “darting” trait is a particular characteristic of tuna, which is a fish of high commercial value.

The sixth embodiment is substantially similar to the fifth embodiment, except that the tank modules are arranged in a regular annular configuration, as opposed to a rectilinear arrangement.

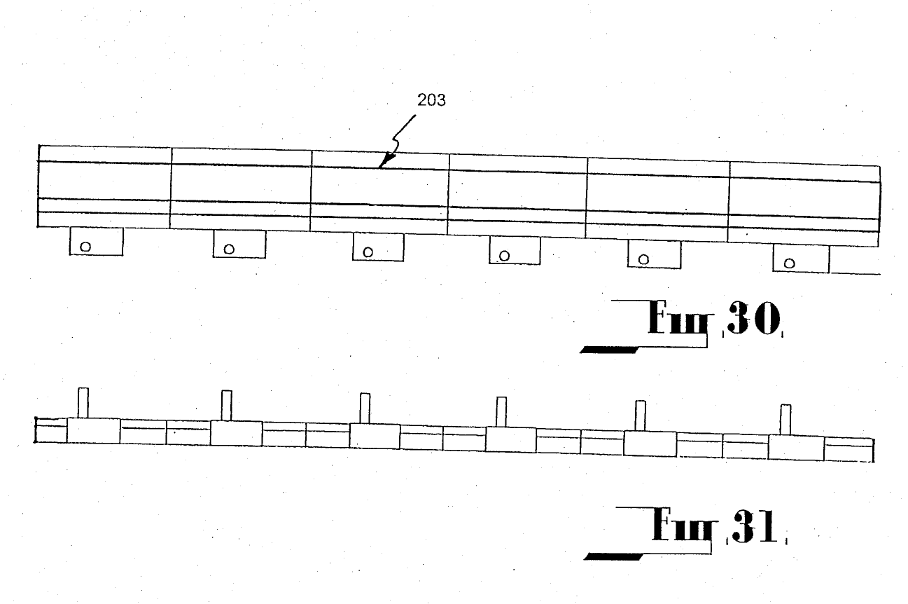

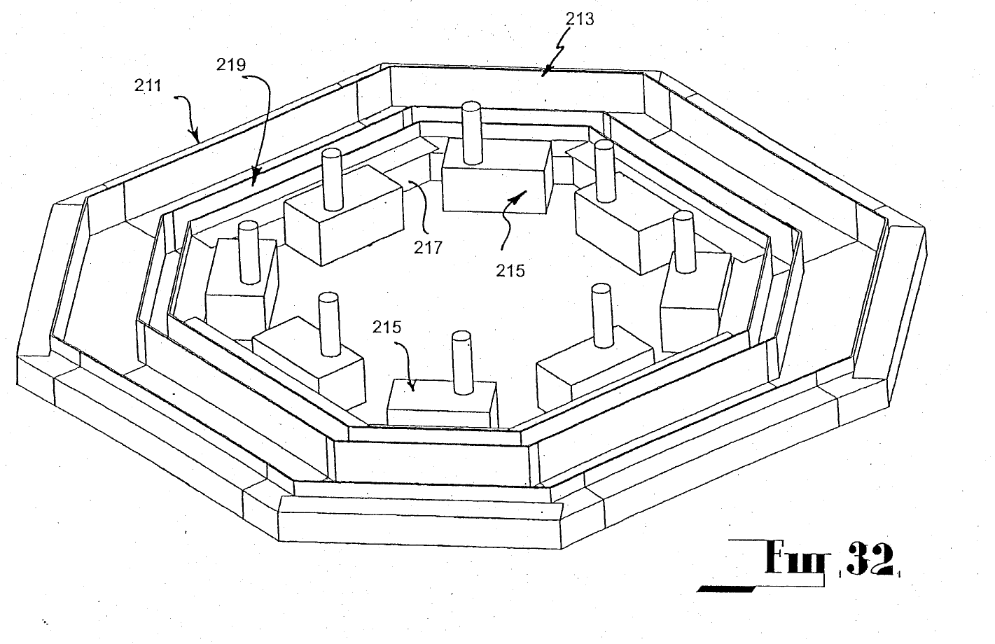

As shown in FIGS. 32 and 33, the tank modules are particularly designed to include straight holding tank modules 221 and angular holding tank modules 223 in an alternating configuration so as to define a regular annular configuration. As shown, none of the holding tanks have end walls and are interconnected to provide for a continuous passage of fluid in an endless loop, longitudinally of the holding tank modules around the annual configuration.

As in the previous embodiment, the service compartments 215 are disposed adjacent the buffer tanks 217 along side the filtering area 219. In the present embodiment, this is on the inner side of the annular arrangement to facilitate servicing and control. A bridge (not shown) can be incorporated to provide access to the inside of the annulus.

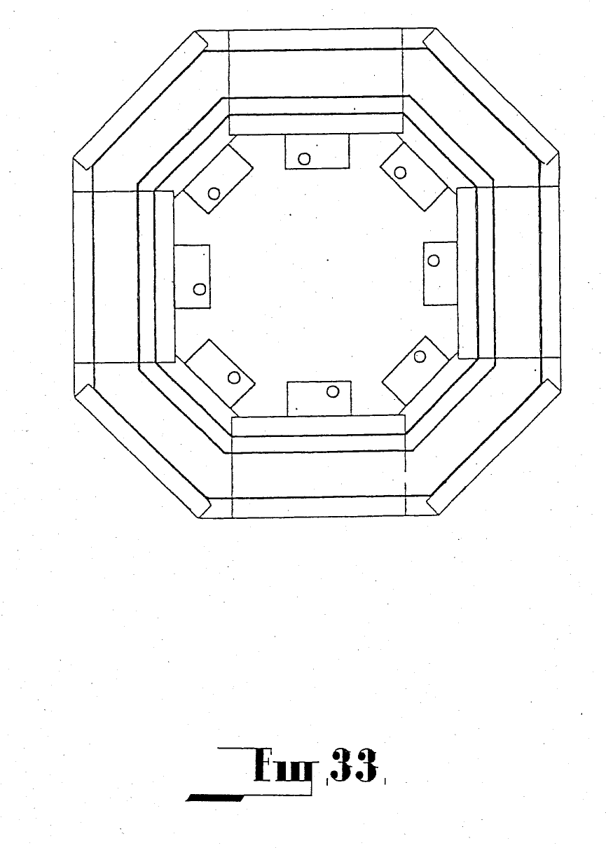

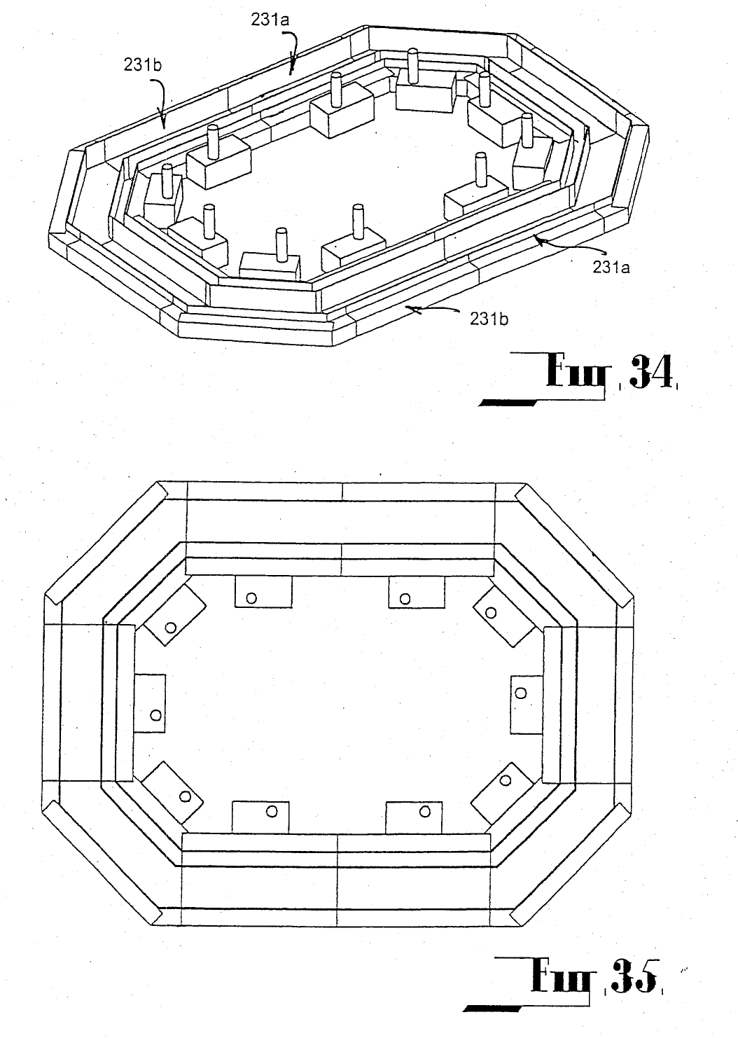

The seventh embodiment is shown in FIGS. 34 and 35 and is directed towards a minor variation on the sixth embodiment. Moreover, the seventh embodiment is directed towards an elongated annular configuration of holding tank modules, whereby a pair of straight section modules 231a and 231b are disposed adjacent each other at opposite sides of the annulus to define an elongated configuration.

The eighth embodiment is a variation of the fifth embodiment, whereby the rectilinear holding tank module configuration is extended with transverse end modules to define a zig-zagging configuration which similarly provides a continuous passage of fluid from one end holding tank module 241a to an opposing end holding tank module 241b, and vice versa.

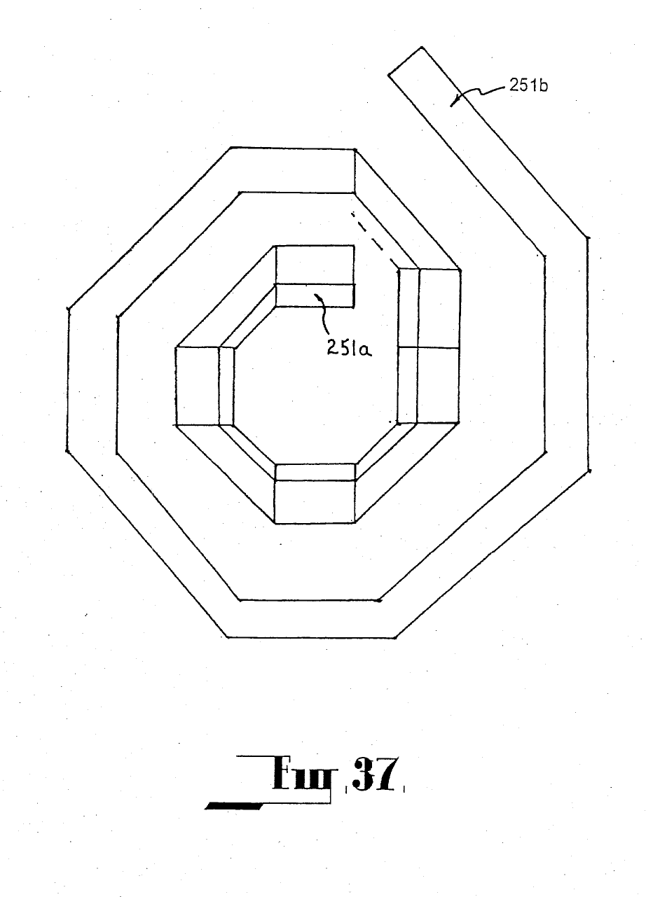

The ninth embodiment is a variation on the same theme as the preceding four embodiments, being alternatively directed towards a convoluted configuration which similarly provides for a continuous passage of fluid from one end holding tank module 251a, via the convoluted configuration, to an opposing end holding tank module 251b, and vice versa, as shown in FIG. 37 of the drawings.

It should be appreciated that the various embodiments two to nine provide a number of new features compared with prior art tank systems. These features are summarised below:

1. There is a uniform cross flow of water in the holding tanks, avoiding the creation of dead spots and thus a non uniform environment for aquatic product disposed within the holding tanks.

2. The biofilter is an integral part of the main tank and its particular arrangement allows for easier maintenance.

3. The buffer tanks double as extra water holding areas, and as shown in the first embodiment, as walkways between tanks systems in a multiple tank system environment.

4. The system normally operates with one main pump as part of the recirculating means for recirculating water throughout the tank system. However, the supplementary pump in the protein circuit can come on line when the water filtering requirement is maximal with heavy aquatic product loads to supplement the action of the biofilter or when the emptying of the tank is required.

5. The biolilter can be oxygen fed for peak loads and provide air stripping of ammonia, if desired by injecting oxygen into the filtering area.

6. The entire system can be monitored via a computer from remote locations.

7. The internal conditions of the tank can be also controlled by means of the computer, from remote locations.

It should be appreciated that the scope of the present invention is not limited to the specific embodiments described herein. For example, in the case of the first embodiment, the invention may have utility in alternative liquid treatment arrangements, where it is desirable to provide a separation of liquid depending on the relative mass or specific gravity of particles contained therein, or where a flotation/fractionation process is used to treat liquid containing solids and waste.

The claims defining the invention are as follows

1. An improvement in a fractionation/flotation system for removing waste such as biosolids, nitrates or nitrites from a liquid containing same comprising: a fractionation column; a foam aggregation chamber surmounting the fractionation column; a liquid inlet means for inletting liquid containing the waste into the fractionation column; pump means for pumping the liquid through the liquid inlet means; gas injecting means for injecting a waste reducing gas such as air, oxygen or ozone into the liquid immediately prior to insetting the same into the fractionation column; foam extracting means to extract foam collected within the foam aggregation chamber; and liquid outlet means for outletting treated liquid from the base of the fractionation column; the improvement residing in:
the liquid inlet means being divided into:
(c) a first liquid inlet for insetting liquid containing waste at an intermediate location along the axial extent of said fractionation column, said first liquid inlet having a flow regulator to control the flow rate of liquid being inlet into the column thereby; and
(d) a second liquid inlet for simultaneously inletting the liquid containing waste at an intermediate, albeit lower, location along the axial extent of said fractionation column than said first liquid inlet, said second liquid inlet having said gas injecting means disposed in series therein for injecting said waste reducing gas into the liquid of the second liquid inlet immediately prior to insetting same within said fractionation column;
wherein the division occurs after the outlet of said pump means;
and wherein liquid within said fractionation column is able to be maintained at an optimum level to enable foam having waste adsorbed thereto to aggregate in said aggregation chamber by controlling said regulator.

2. An improvement as claimed in claim 1, wherein said gas injecting means comprises a venturi whereby said waste reducing gas is drawn into the throat of the venturi to permeate and aerate the liquid containing waste passing through the venturi.

3. An improvement as claimed in claim 1 or 2, wherein said waste reducing gas is a mix of oxygen and ozone.

4. An improved method for controlling the removal of waste such as biosolids, nitrates or nitrites from a liquid containing same using a fractionation/flotation system comprising: a fractionation column; a foam aggregation chamber surmounting the fractionation column; foam extracting means to extract foam collected within the foam aggregation chamber; and liquid outlet means for outletting treated liquid from the base of the fractionation column; the method comprising:
inletting liquid containing waste under pressure into the fractionation column at first and second intermediate locations from a common source, the second location being lower than the first location;
injecting a waste reducing gas such as air, oxygen or ozone into the liquid immediately prior to inletting the same into the fractionation column at the second intermediate location; and
regulating the flow of liquid being inlet at the first intermediate location to maintain the liquid within the fractionation column at an optimum level for enabling foam having waste adsorbed thereto to aggregate in the aggregation chamber.

5. An improved method as claimed in claim 4, wherein said waste reducing gas is a mix of oxygen and ozone.

6. An apparatus for separating liquid containing particles of varying mass or specific gravity comprising:
an elongated passageway having: (a) a leading wall with a primary lip for liquid containing said particles to flow over into said passageway; (b) a trailing wall with secondary lip disposed lower than said primary for liquid to flow over and out of said passageway; and (c) a base closing the bottom of said passageway to enable the liquid flowing into the passageway over said primary lip to fill the same and flow out over the secondary lip;
flow diverting means disposed in said passageway for diverting the liquid flow therein to create a convolving recirculating portion of laminar flow and a discharging portion of laminar flow of liquid within the passageway; and
liquid extraction means to extract liquid containing particles of lower mass or specific gravity entrained within said recirculating portion therefrom, leaving liquid containing particles of waste to flow out of said passageway and over the secondary lip.

7. An apparatus as claimed in claim 6, wherein said flow diverting means comprises a circular pipe disposed in parallel and spaced relationship to the longitudinal extent of the walls and base.

8. An apparatus as claimed in claim 7, wherein said circular pipe is disposed closer to the base and the trailing wall than to the leading wall and the lips.

9. An apparatus as claimed in claim 7 or 8, wherein said liquid extracting means comprises a plurality of rectilinearly aligned holes disposed axially along the suction pipe at spaced apart locations and suction means to apply a negative pressure to the inside of the circular pipe to draw liquid from said recirculating portion.

10. An apparatus as claimed in claim 9, wherein said holes are disposed in the half of the pipe confronting the leading wall to repose in the recirculating portion of the liquid within the passageway.

11. An apparatus as claimed in claim 10, wherein said holes are disposed in the upper quartile of said half of the pipe.

12. An apparatus as claimed in claim 11, wherein said holes are disposed at approximately 45° from the vertical.

13. An apparatus as claimed in any of claims 6 to 12, wherein said liquid extraction means is connected to the inlet of a fractionation/flotation system for removing waste including said particles entrained within the extracted liquid therefrom.

14. An apparatus as claimed in claim 13, wherein said fractionation/flotation system is as claimed in any one of claims 1 to 3.

15. An apparatus as claimed in any one of claims 6 to 14, wherein said secondary lip directs discharged liquid to a filtering means.

16. An apparatus as claimed in claim 15, wherein said filtering means is a biofilter.

17. A method for separating liquid containing particles of varying mass or specific gravity comprising:
cascading liquid containing said particles over a primary lip into a passageway;
diverting the flow of the liquid within the passageway to create a convolving recirculating portion of laminar flow and a discharging portion of laminar flow;
extracting liquid containing particles of lower mass or specific gravity entrained within said recirculating portion therefrom; and
discharging liquid containing particles of higher mass or specific gravity entrained within said discharging portion out of said passageway over a secondary lip.

18. An improvement in a fractionation/flotation system for removing waste such as biosolids, nitrates or nitrites from a liquid containing same substantially as herein described with respect to the drawings as appropriate.

19. An improved method for controlling the removal of waste such as biosolids, nitrates or nitrites from a liquid containing same using a fractionation/flotation system substantially as herein described with reference to the accompanying drawings as appropriate.

20. An apparatus for separating liquid containing particles of varying mass or specific gravity substantially as herein described with reference to the accompanying drawings as appropriate.

21. A method for separating liquid containing particles of varying mass or specific gravity substantially as herein described with reference to the accompanying drawings as appropriate.

22. A tank system for accommodating aquatic life substantially as described herein in any one of the embodiments with reference to the accompanying drawings as appropriate.

23. A method for accommodating aquatic life substantially as described herein in any one of the embodiments with reference to the accompanying drawings as appropriate.
